(19) United States
(12) Patent Application Publication
(10) Pub. No.: US 2026/0320723 A1
(43) Pub. Date: Oct. 15, 2026

(54) SYSTEM AND METHOD FOR OPERATING A HEDGING AND DERIVATIVE MARKET FOR SPORT BETTING

(71) Applicant: HedgeBettor Technologies, LLC, Braintree, MA (US)

(72) Inventors: Justin W. Fein, Braintree, MA (US); Daniel J. O'Keefe, Braintree, MA (US)

(21) Appl. No.: 19/686,263

(22) Filed: May 22, 2026

Related U.S. Application Data
(63) Continuation of application No. 19/448,012, filed on Jan. 13, 2026.
(60) Provisional application No. 63/787,552, filed on Apr. 11, 2025.

(51) Int. Cl. G06Q 50/34; G07F 17/32

(52) U.S. Cl. CPC G06Q 50/34; G07F 17/3244; G07F 17/3288; G07F 17/3237

(57) ABSTRACT

A secondary market platform that forms consolidated sale liquidity pools and consolidated buy liquidity pools organized by bet outcomes (e.g., Team A wins outright, Player B scores 2 touchdowns, etc.) may be established for sports bettors, thereby enabling other sports bettors to purchase any portion of or an entirety of sports bets of sports events having the same bet outcomes that are made available for sale to be purchased. The consolidated liquidity sale pools and consolidated liquidity buy pools may each be set up with a first-in, first-out structure such that hedge bets, which may be a portion of or an entirety of a sports bet, may be made available for sale by owners. By using a FIFO structure, owners of the bets may be motivated to submit the hedge bets into the pools early so as to create a vibrant secondary market for the sports bets.

### RELATED APPLICATIONS

This Application is a continuation of U.S. application Ser. No. 19/448,012, filed Jan. 13, 2026, which claims priority to U.S. Provisional Patent Application No. 63/787,552 filed Apr. 11, 2025; the contents of which are incorporated herein by reference in their entirety.

### BACKGROUND OF THE INVENTION

Sports betting is one of the most popular forms of gambling because it involves two popular human activities, gambling and sports. The ability to bet on a favorite sports team and/or players adds to the excitement of sports betting. In cases where gamblers have participated in sports, the gamblers find that their sports knowledge gives them an advantage in making bets. Sports betting exists at various levels of sports, including professional and amateur sports. Historical sports betting was made by book makers or “bookies” who determine gambling odds. Bookies, however, have been and remain illegal in most states for a variety of reasons, although illicit bookies exist so as to avoid being regulated or taxed.

The advent of the Internet revolutionized sports betting. Online sportsbooks and betting exchanges or platforms were created and now provide unprecedented access to odds and wagering opportunities for sports bettors. Online betting platforms allow for real-time odds updates and a broader range of betting options. The introduction of mobile betting apps has further enhanced sports betting accessibility. These online sportsbooks or books platforms have been legalized and are subject to regulation and taxes.

Despite the increased availability of sports betting platforms, there remains a number of shortcomings of such platforms that are limiting to sports bettors (generally considered herein as individuals who place bets via the online sportsbooks or sports betting platforms). For example, when a sports bettor places bets with odds established by odds makers, the bet is locked in until the conclusion of the sporting event or sports competition (e.g., football game) or the sportsbook repurchases the bet. In sports, injuries and other situations that occur prior to or during a sporting event (e.g., football game) may change the odds of the competition, sometimes dramatically. In such odds-changing situations, the sports bettor may find that the bets have a higher or lower probability of winning. In either case, the sports bettor has no choice but to await the fate of the bet or, in many cases, hope that the sportsbook is willing to repurchase the bet. As such, there is a need for expanded capabilities and flexibility for sports bettors who have placed bets with sports betting platforms.

### BRIEF SUMMARY

To overcome the problems of existing sports betting platforms providing limited flexibility for sports bettors who have purchased bets, especially in the event of an odds changing situation prior to or during a sporting event, the principles provided herein support hedging and/or a derivative betting market platform for existing bets that are made on an online sports betting platform. In an embodiment, the hedging and/or derivative sports betting market platform, also described herein as a secondary sport betting market platform, may be independent of a sports betting platform or may be integrated therein.

The secondary sports betting market platform may enable a sports bettor to sell a portion of or an entire sports bet or wager, thereby enabling a sports bettor to hedge a bet and/or sell a derivative of a sports bet. Sports bets have current or dynamic odds (i.e., win percentage or probability) that dynamically vary for a wide variety of reasons, such as health of sports competitor(s) (e.g., player of a sports team), weather conditions, time of day, temperature, opposing competitors, streak or slump, and/or many other reasons (e.g., change of score during a game). A bettor with an existing bet may desire to sell some or all of the bet to offset the original bet based on current odds that may have varied from the odds of the original bet. The secondary sports betting market platform may provide for consolidated liquidity pools as opposed to individual order matching, thereby aggregating bets with the same outcome. The consolidated liquidity pools simplify market participation of bettors (both sellers and buyers) and enhances liquidity for both buyers and sellers of sports bets. In an embodiment, probability or price thresholds may be used for triggering automated execution when a set range is met (e.g., current estimated win percent is within a range of win percent established by a sports bettor for a particular bet). The secondary sports betting market platform may utilize a first-in, first-out (FIFO) execution model, which may motivate sellers and buyers of sports bets to establish selling and buying pools of sports bets with common odds to enter sooner. The use of these and other secondary sports betting market platform features may enable liquidity of sports bets for sports bettors as compared to existing sports betting platforms that sell initial sports bets.

One embodiment of a computer-implemented method may include receiving, by at least one processor from a first client device, a first data object including data associated with a first sports bet owned by a first sports bettor as made on a sports event, the data including (i) a first sports event identifier, (ii) a first bet outcome identifier, and (iii) a first hedge bet value less than or equal to a bet value of the first sports bet, the first hedge bet value selectably made available for resale by the first sports bettor. In response to the at least one processor determining that the first data object includes a first instance of the first bet outcome identifier associated with the first sports event identifier, dynamically creating, by the at least one processor, a consolidated sale liquidity pool associated with the first sports event identifier and the first bet outcome identifier. The consolidated sale liquidity pool consolidates multiple hedge bets to optimize efficiency of energy usage and communications signals in conducting transactions of the hedge bets of the sports event. The processor(s) may first index the first data object with the consolidated sale liquidity pool. A current total sale pool value parameter may be initialized by the processor(s) to store a total sale pool value of the consolidated sale liquidity pool with the first hedge bet value. The processor(s) may communicate at least one of the first event identifier, first bet outcome identifier, and current total sale pool value to enable users of other client devices to access the consolidated sale liquidity pool via a user interface and to submit respective buy orders to buy up to the current total sale pool value. A second data object including data associated with a second sports bet owned by a second sports bettor as made on the sports event may be received by the processor(s) from a second client device. The data may include (i) the first sports event identifier, (ii) the first bet outcome identifier, and (iii) a second hedge bet value less than or equal to a bet value of the second sports bet. The second hedge bet value may be selectably made available for resale by the second sports bettor. In response to the processor(s) determining that the second sports bet includes a second instance of the first bet outcome identifier associated with the first sports event identifier, the second data object may be second indexed with the consolidated sale liquidity pool. In response to the second data object being second indexed with the consolidated sale liquidity pool, an updated current total sale pool value may be calculated by adding the second hedge bet value with the current total sale pool value. The updated current total pool value of the consolidated sale liquidity pool may be communicated by the processor(s) to enable the users of the other client devices to access the consolidated sale liquidity pool via the user interface and submit respective buy orders to buy up to the updated current total sale pool value, the buy orders being at least a fraction of the first and second hedge bet values.

One embodiment of a system may include a non-transitory memory configured to store data associated with sports bets, an input/output (I/O) unit (.e., with one or more transceiver chips), and at least one processor in communication with the non-transitory memory and I/O unit. The processor(s) configured to receive, from a first client device, a first data object including data associated with a first sports bet owned by a first sports bettor as made on a sports event. The data may include (i) a first sports event identifier, (ii) a first bet outcome identifier, and (iii) a first hedge bet value less than or equal to a bet value of the first sports bet. The first hedge bet value may selectably made available for resale by the first sports bettor. In response to determining that the first data object includes a first instance of the first bet outcome identifier associated with the first sports event identifier, the processor(s) may dynamically create a consolidated sale liquidity pool associated with the first sports event identifier and the first bet outcome identifier. The consolidated sale liquidity pool may consolidate multiple hedge bets to optimize efficiency of energy usage and communications signals in conducting transactions of the hedge bets of the sports event. The first data object may be first indexed with the consolidated sale liquidity pool. A current total sale pool value parameter may be initialized (e.g., memory address selected and optionally set to a zero value prior to other data being stored therein) to store a total sale pool value of the consolidated sale liquidity pool with the first hedge bet value. The processor(s) may communicate (optionally via the I/O unit) at least one of the first event identifier, first bet outcome identifier, and current total sale pool value to enable users of other client devices to access the consolidated sale liquidity pool via a user interface and to submit respective buy orders to buy up to the current total sale pool value. A second data object including data associated with a second sports bet owned by a second sports bettor may be receive from a second client device as made on the sports event. The data may include (i) the first sports event identifier, (ii) the first bet outcome identifier, and (iii) a second hedge bet value less than or equal to a bet value of the second sports bet. The second hedge bet value may be selectably made available for resale by the second sports bettor. In response to determining that the second sports bet includes a second instance of the first bet outcome identifier associated with the first sports event identifier, the processor(s) may second index the second data object with the consolidated sale liquidity pool. In response to the second data object being second indexed with the consolidated sale liquidity pool, an updated current total sale pool value may be calculated by adding the second hedge bet value with the current total sale pool value. The updated current total pool value of the consolidated sale liquidity pool may be communicated to enable the users of the other client devices to access the consolidated sale liquidity pool via the user interface and submit respective buy orders to buy up to the updated current total sale pool value. The buy orders may be at least a fraction of the first and second hedge bet values.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of an illustrative conventional online sports betting environment in which sports bettors place initial bets on sporting events via a computer network with online sports betting platforms;

FIG. 2A is an illustration of an illustrative sports betting environment in which sports bettors place initial bets on sporting events via a computer network with traditional online sports betting platforms and a secondary market platform that supports hedging and/or derivatives for the bets placed by sports bettors with the sports betting platforms;

FIG. 2B is an illustrative of an illustrative sports betting environment showing the secondary market platform of FIG. 2A including a set of first-in-first-out (FIFO) consolidated liquidity pools, both consolidated sale and buy liquidity pools, that have current odds set by an odds maker for each of the pools for sellers of sports bets to accept in selling at least a portion of an existing bet and buyers to purchase from the pools;

FIGS. 3A-3E are screen shots of a user interface for buyers and sellers of sports bets to participate in the secondary market platform of FIGS. 2A and 2B;

FIG. 4 is a network environment in which a secondary market platform for supporting buying and selling of sports bets using consolidated sale and buy liquidity pools and consolidated sale and buy liquidity ledgers with FIFO processing; and

FIGS. 5A-5C are flow diagrams of an illustrative process for supporting the secondary market platform for buying and selling of sports bets using consolidated sale and buy liquidity pools and consolidated sale and buy liquidity ledgers with FIFO processing.

### DETAILED DESCRIPTION OF THE DRAWINGS

The principles described herein support a secondary sports betting market platform that forms consolidated sale and buy liquidity pools and ledgers that are organized by bet outcomes (e.g., Team A wins outright, Player B scores 2 touchdowns, over/under 58 ½ points, etc.), thereby enabling other users to purchase any portion of or an entirety of bets of the same bet outcomes that are being made available for sale by bet owners to be purchased. By aggregating or pooling common bet outcomes of multiple bets from one or more bettors, inefficiencies of computing, communications, and energy consumption by matching may result in a significantly higher efficiency of a market that reduces computing, communications, and energy consumption may result. In other words, previous attempts failed to efficiently match buyers and sellers, thus being unable to make an efficient marketplace for secondary bet sales.

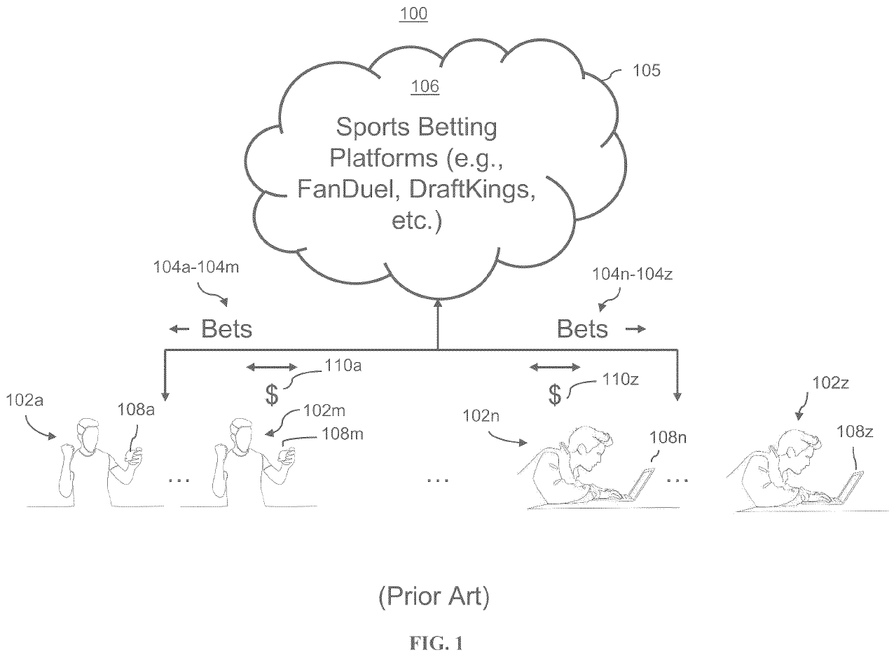

With regard to FIG. 1, an illustration of an illustrative conventional sports betting environment 100 in which sports bettors 102a-102m and 102m-102z (collectively 102) place initial bets 104a-104z (collectively 104) on sporting events via a computer network or cloud 105 with online sports betting platforms 106, such as FanDuel, DraftKings, etc., is shown. Sports bettors 102 who are buyers of bets or wagers of sporting events (or other events on which bets may be placed) may use different forms of electronic communications devices 108a-108z (collectively 108), such as mobile electronic devices (e.g., smart phones, laptop computers, desktop computers, etc.) for accessing the sports betting platforms. Although shown in the cloud 105, the sports betting platforms 106 may be operated on servers in communication with one or more communications networks with which the cloud 105 or operated locally by the respective sport betting platforms 106. The sports bettors 102 may have an account with one or more of the respective sports betting platforms 106 for purchasing the sports bets 104 of a certain outcome (e.g., Team A wins by 3 points) having odds set by book makers. The book makers may or may not be the sports betting platforms 106 themselves (i.e., the sports betting platforms 106 may use a trusted odds maker). Artificial intelligence book makers may also be utilized to support a sports betting platform.

As an example, when the sports bettors 102 make a bet, money 110a-110z (collectively 110) may be drawn from the account of the sports bettor 102a with the sports bettor platform or otherwise (e.g., a bank account, online account, etc.), as understood in the art. The bets 104 of the sports bettors 102 may be stored in respective accounts of the sports bettors 102, which may include sending the purchased bets 104 in the form of data objects inclusive of data and/or metadata inclusive of information related to the purchased sports bets 104. It should be understood that any data protocol or format may be utilized to support the purchased sports bets 104. For example, the data objects may include a bet identifier, sporting event identifier, bettor or account identifier, outcome of the bet, bet purchase price, odds of the original bet, timestamp of the bet, date and time of the sporting event, and so on. In the event of a bet being a winning bet, money 110 may be applied to the account of the respective sports bettors 102 with the respective one of the sports betting platforms 106. In an embodiment, the accounts of the sports bettors 102 may include or support integration with digital wallets, online bank accounts, accounts managed by the sports betting platforms 106 at a traditional or non-traditional bank, etc.

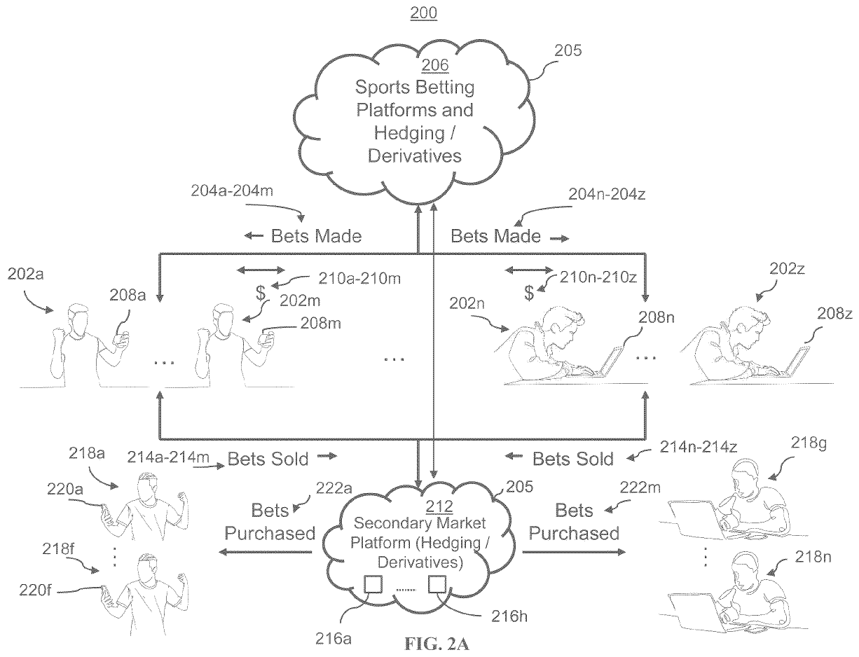

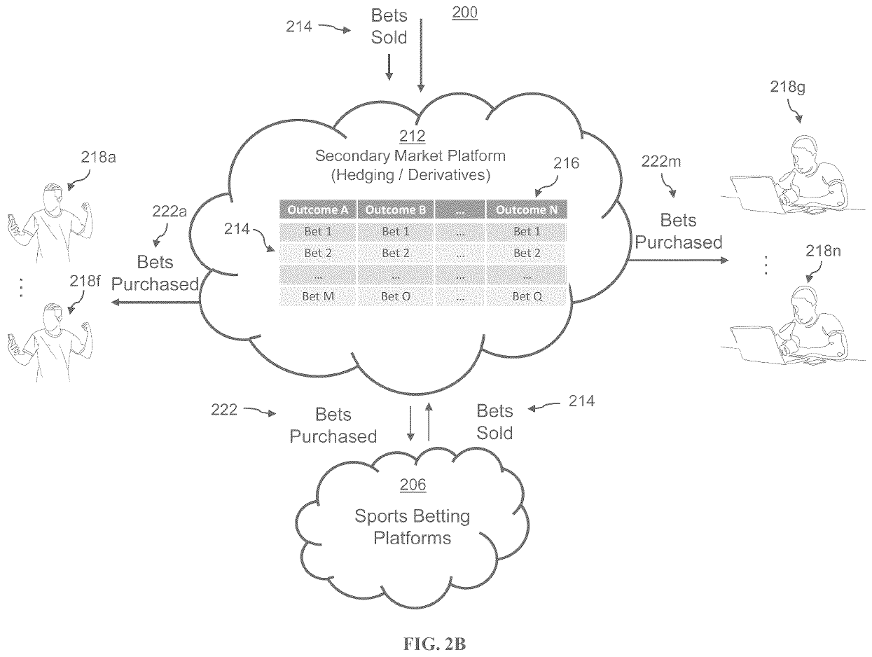

With regard to FIG. 2A, an illustration of an illustrative sports betting environment 200 in which sports bettors 202a-202m and 202n-202z (collectively 202) place initial or original bets 204a-204m and 204n-204z (collectively 204) on sporting events via a computer network or cloud 205 with online sports betting platforms 206 and a secondary market platform 212 that supports hedging and/or derivatives for the bets 204 placed with sports betting platforms 206 is shown. As indicated, the sports betting platforms 206 may be integrated with a hedging and/or derivative platform, where the integration may be via an application programming interface (API) to provide seamless access. The sports bettors 202 who made the respective initial sports or initial bets 204 via electronic devices 208 a-208m and 208 n-208z (collectively 208) by paying respective money or value 210a-210m and 210n-210z (collectively 210) therefor may resell a fraction or an entirety of one or more of the bets 204 as hedge amounts or hedge bets 214a-214m and 214n-214z (collectively 214) via the secondary market platform 212. The That is, a fraction or an entirety of each of the bets 204 may be sold as the hedge bets 214 to hedge or create derivatives of the initial bets 204 by selling (i) a portion of a bet or (ii) an entirety of a bet. It should be understood that the sports bettors 202 may elect to not sell any portion of their initial bets 204, as well. As understood, the sports bets 204 have odds or winning percent that are continuously changing based on a number of factors, such as health of sports players or event participants, recent performance of players, market sentiment, political situations, weather factors, and many other factors.

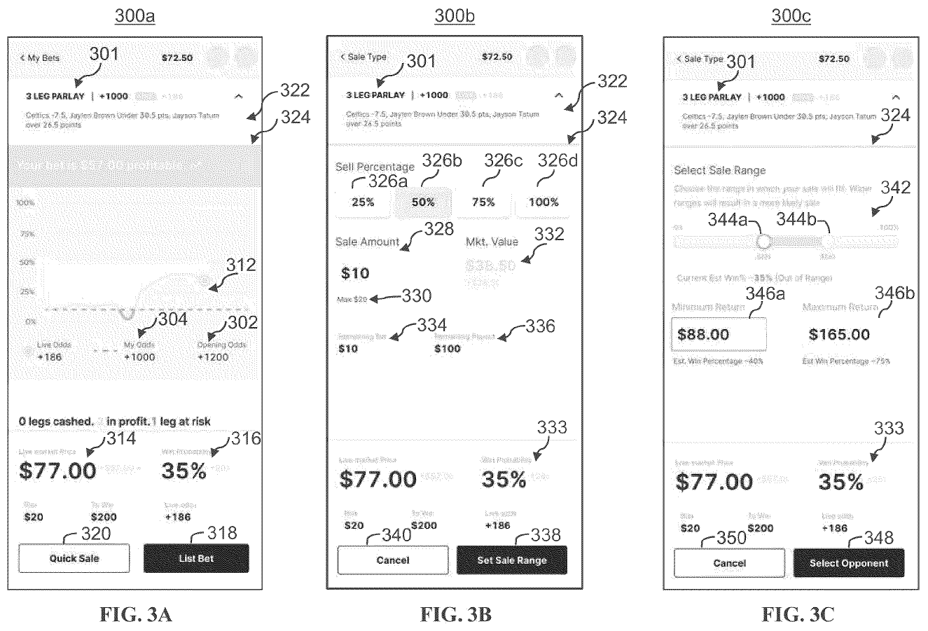

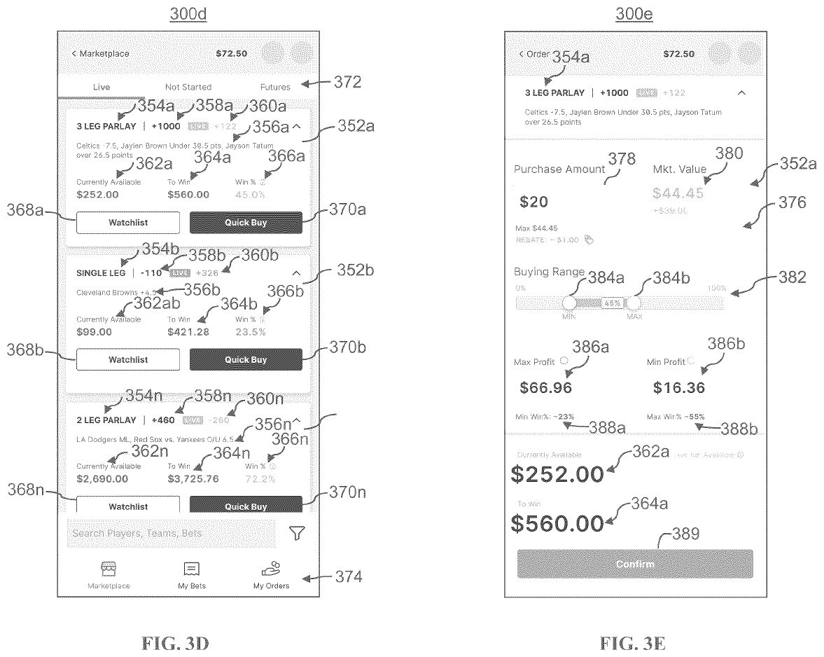

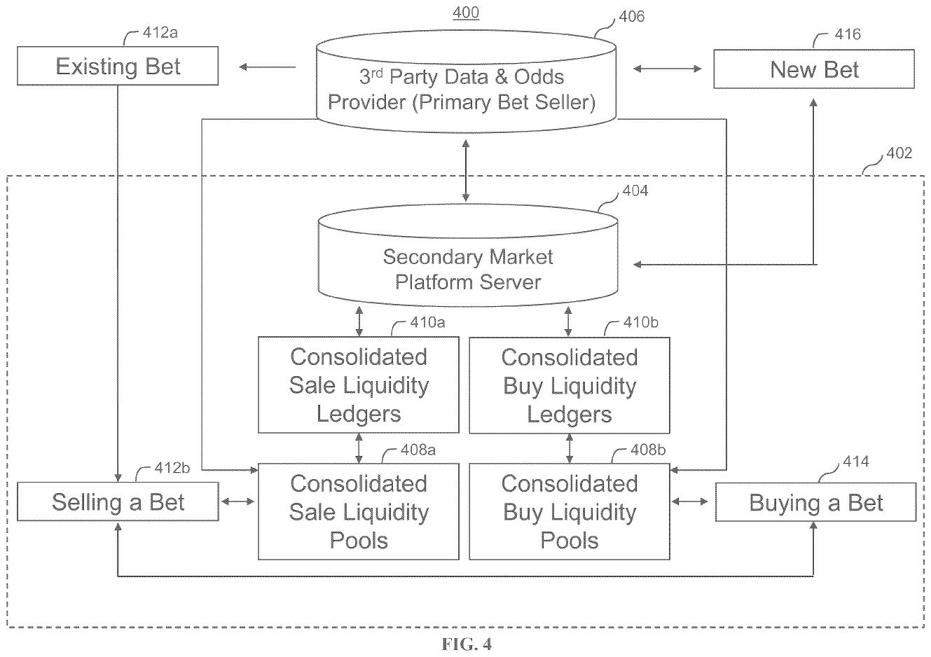

To sell the hedge bets 214 (i.e., fraction of or entirety of the bets 204) via the secondary market platform, the sports bettors 202 may use a user interface, such as shown in FIGS. 3A-3C. The hedge bets 214 that are sold may be entered into consolidated sale liquidity pools 216a-216h (collectively 216) based on outcomes that are dynamically created by the sports bettors 202 when hedging their bets 204 by selling the hedge bets 214 into the consolidated sale liquidity pools 216 associated with bet outcomes. Win percent of the bets 204 and 214 are dynamically set and/or adjusted by odds makers, as further described herein. Although not shown, the bets 204 and 214 may include a bet value parameter along with other parameters that identify the sports event, bet outcome, sports bettor, and/or otherwise, as further described herein.

Each of the consolidated sale liquidity pools 216 associated with by bet outcomes may be different such that secondary sports bettor buyers 218a-218f and 218g-218n (collectively 218) using electronic devices 220 a-220f and 220 g-220n (collectively 220) may elect to purchase fractions of or entirety of derivative bets 214 that are available in the respective consolidated sale liquidity pools 216 as bets 222a-222m (collectively 222). However, in buying the hedge bets 214 from the respective consolidated sale liquidity pools 216, the hedge bets 214 may be purchased in a first-in, first-out (FIFO) manner and without regard to individual fractions or entirety of the value of the individual hedge bets 214. As shown, each of the hedge bets 214 may be indexed in the consolidated sale liquidity pools 216 in that Bet 1 is indexed in a first position, Bet 2 is indexed in a second position, Bet M is indexed in an M position, and the indexing may be performed in a time-sequential order (i.e., indexed based on a time that the hedge bets 214 are received). For example, the secondary sports bettor buyers 218 may purchase any portion of the total aggregated value of the hedge bets 214 in the consolidated sale liquidity pools 216. In an embodiment, the sports betting platforms 206 may be enabled to have priority over the secondary sports bettor buyers 218. It should be understood that the consolidated sale liquidity pools 216 may be classified by bet outcomes as a defining characteristic because outcomes are a typical way that the or initial bets 204 are made (e.g., bet that a final score will be over 56 ½ points).

With regard to FIG. 2B, an illustration of the illustrative sports betting environment 200 showing the secondary market platform 212 of FIG. 2A including the consolidated sale liquidity pools 216 configured as a set of first-in-first (FIFO) lists organized by different bet outcomes A-N with a different number of hedge bets 214 in each of the pools 216 is shown. Odds for each of the pools 216 may dynamically change based on book makers changing odds for the respective consolidated sale liquidity pools 216 for sellers of the hedge bets 214 to accept in selling at least a portion or fraction of an existing initial bet 204 and buyers to purchase from the consolidated sale liquidity pools 216. The secondary market platform 212 may support conditional future sales orders of the hedge bets 214 by establishing a range of a winning percent for the bet outcome and/or other parameter(s) of the event. The FIFO execution or listing model establishes that hedge bets 214 sold into the consolidate liquidity pools 216 earlier are prioritized ahead of later sold hedge bets 214 with common bet outcomes, thereby enhancing fairness and predictability in trade execution and inspiring competition and strategy for the sports bettors 202. The secondary market platform 212 enables (i) the sports bettors 202 to sell the hedge bets 214 and (ii) sports bettors 218 to buy the hedge bets 214 at any desired amount, even down to the penny, as purchased hedge bets 222, thereby enabling greater flexibility and lowering barriers to entry into selling and buying via the secondary market platform 212. As further described herein, the secondary market platform 212 may support aggregation of bet orders by the sports bettors 218.

The secondary market platform 212 may use the consolidated sale liquidity pools 216 to aggregate hedge bets 214 with the same outcome (e.g., outcomes A-N), thereby simplifying market participation and enhancing liquidity for both sports bettor sellers and buyers 202 and 218. The consolidated sale liquidity pools 216 may group bets based on bet outcome alone, regardless of the individual wager amount or odds received at the time of placement or purchase of the initial bets 204, thereby also creating uniformity in valuation and trading in the secondary market. The secondary market platform 212 may use a straightforward probability-based model, where the fair market value of a hedge bet 214 (i.e., a fraction or entirety of the initial bets 204) is determined by: Fair Market Value of Bet=(Current Probability of Success)×(Payout), which ensures transparent, real-time pricing directly tied to probability instead of external market sentiment. As an alternative to market makers setting odds, the liquidity pools 216 themselves may act as the market maker, thereby aggregating the hedge bets 214 in each of the outcomes A-N available for purchase or sale.

The secondary market platform 212 may also enable (i) the sports bettors 202 to place conditional future sell orders of the initial bets 204 based on an expected win percent or probability of a sports event and (ii) the sports bettors 218 to place conditional future buy orders based on expected win percent or probability of a sports event. Placing conditional future orders, sell and buy orders, allow the sports bettors 218 to sell the hedge bets 214 automatically or semi-automatically (e.g., prompt the sports bettors 202 and 218 prior to transaction execution) at a later point when conditions align with the set probability range(s). In other words, the secondary market platform 212 may enable the secondary sports bettor sellers 202 and/or buyers 218 to set bet win probability ranges that may support automatic sell and buy orders to be executed, as further described herein. In operation, the secondary market platform 212 may allow users to set probability or price thresholds, which may trigger automated execution when the set ranges by the sports bettors 202 and secondary sports bettors 218 are met. The sports bettors 202 and 218 may pause, edit, or cancel buy and sell orders before any or total fulfillment. In an embodiment, the secondary market platform 212 may enable the sports bettors 202 and 218 to confirm the buy or sell orders prior to execution so as to be semi-automatic as opposed to fully automated. In an embodiment, the secondary market platform 212 may be fully automated once the hedge bets 214 and on the secondary market in the consolidated sale liquidity pools 216 and a winning percent of the associated bet outcome is within a range established by the sports bettor 202a, for example, as further described herein. It is noted that each of the sports betting platforms 206 may have a secondary sports betting platform 212 to avoid complex transactions and communications, but it is possible for an integrated secondary sports betting platform that accepts hedge bets 214 from different sports betting platforms 206.

More specifically, a consolidated sale liquidity pool (e.g., consolidated sale liquidity pool having Outcome A) may be created when a sports bettor 202 sells a bet or fraction thereof (e.g., 25%, 50%, 75%, 100%) on the secondary market platform 212. The first sports bettor 202 to sell a specific bet outcome (e.g., bet outcome being “more than 250 passing yards”) causes a secondary market platform system to initiate or create a consolidated sale liquidity pool for that bet outcome with the bet (“Bet 1”) being sold. As provided above, each of the consolidated sale liquidity pool corresponds to a unique bet outcome, such as over/under 55 points in a game. If multiple users sell hedge bets 214 with the same bet outcome (e.g., “Outcome A”), the hedge bets 214 are aggregated into the same consolidated sale liquidity pool. In other words, the consolidated sale liquidity pools 216 are created based on bet outcomes available on one or more of the sportsbook or sports betting platforms 206, then the secondary market platform 212 may ensure that hedge bets 214 with the same parameters (e.g., outcomes) are grouped or pooled together. Each of the consolidated sale liquidity pools 216 may grow as more users sell bets with the same bet outcome(s), thereby allowing secondary sports bettor buyers 218 to purchase portions or the entirety of the aggregated hedge bets 214 in one or more of the consolidated sale liquidity pools 216. The secondary sports bettor buyers 218 may, therefore, purchase a total value of bets in the respective consolidated sale liquidity pools 216 from one or more of the sports bettors 202 who sell the hedge bets 214 with the same bet outcome. The ability for the secondary sports bettor buyers 218 to purchase any amount of value from the consolidated sale liquidity pools 216 avoids the secondary sports bettor buyers 218 having to purchase entire bets from individual users, which lends itself to higher market efficiency and lower computing and communications energy usage. By consolidating the hedge bets 214, optimization efficiency of energy usage and communications signals are optimized as compared to if the sports bettors communicate directly with one another to purchase existing sports bets.

As previously described, in addition to the secondary sports bettor buyers 218 being able to purchase from the consolidated sale liquidity pools 216, the sports betting platforms 206 may be able to purchase from the consolidated sale liquidity pools 216, and may be afforded a priority position above the secondary sports bettor buyers 218. Overall, the consolidated sale liquidity pools 216 may be created dynamically based on sale of the initial bets 204 by the sports bettors 202 and are aggregated to reflect the same bet outcomes, thereby ensuring efficient and fair market transactions.

With regard to FIGS. 3A-3E, screen shots of respective user interfaces 300a-300e (collectively 300) for sports bettor buyers and sellers to participate in the secondary market platform 212 of FIGS. 2A and 2B are shown. The user interfaces 300 may be used to facilitate efficient secondary sports bet transactions. User interfaces 300a-300c may be used by sports bettors 202 to sell fractions of a bet or an entire initial bet 204 as hedge bets 214, in this case the bet is a “3 Leg Parlay” 301 including the “Celtics-7.5, Jaylen Brown Under 30.5 pts, Jayson Tatum over 26.5 points,” and user interfaces 300 d and 300 e may be used by secondary sports bettors 218 (FIGS. 2A and 2B) to buy the hedge bets 214 sold into consolidated sale liquidity pools operated by the secondary market platform 212. As shown in FIG. 3A, a user or sports bettor may perform bet management (e.g., hedging and/or derivatives) of an individual bet by the user interface 300a displaying the user's original purchased odds (“Opening Odds”) 302, owned bet odds (“My Odds”) 304, current odds (“Live Odds”) 306 showing increased or decreased odds, current price “Live Market Price” 308 along with profit or loss 310 (in this case up $79), and other information, such as a graph 312 showing live odds over time. A live market price 314 of a bet and win probability 316 may also be listed. The user may select a button 318 to list the bet currently being viewed. Another button 320 may enable the sports bettor to perform a quick sale onto the secondary market via the secondary market platform 212. It should be understood that the user interface 300a is illustrative and that additional and/or alternative functional features and information may be presented in the same or different format.

As shown in FIG. 3B, the screen shot of a user interface 300b that supports the sports bettor in selling the bet is shown. The user interface 300b may simply be a transition from user interface 300a by including a common top portion 322 and replace a bottom portion 324 of the user interface of FIG. 3A. As shown, buttons 326 a-326d (collectively 326) predefined sell percentages (e.g., 25%, 50%, 75%, 100%) may enable a sports bettor to select any of the predefined sell percentages of the bet as a hedge bet. A sale amount field 328 may enable a user to enter a specific amount to sell part of the bet or the specific amount may be automatically calculated and displayed in the field 328 based on a selected button (e.g., button 326b) by the sports bettor. As shown, the user has entered $10, which is 50% of a maximum value 330, in this case $20, and having a market value 332 of $49.50. That is, the user interface 300b may calculate a market value 332 or dynamic sale price based on an estimated win probability 333 and show a remaining value 334 of the unsold or remaining portion of the bet, in this case $10, along with a remaining payout 336, which is half of the original payout if the full original bet of $20 was maintained. By selling 50% of the original bet, the player may immediately be paid $ 49.50 (optionally less a transaction fee) or market value 332, thereby locking in a profit while allowing the remaining bet portion 334 of the original bet to ride (i.e., to hold as a bet until sold as a hedge or until the sports event is completed). After the fraction of the bet or entire bet is set, the sports bettor may select button 338 to set an estimate bet winning range and/or a profit range in a next user interface 300c of FIG. 3C or cancel selling the bet by selecting a cancel button 340.

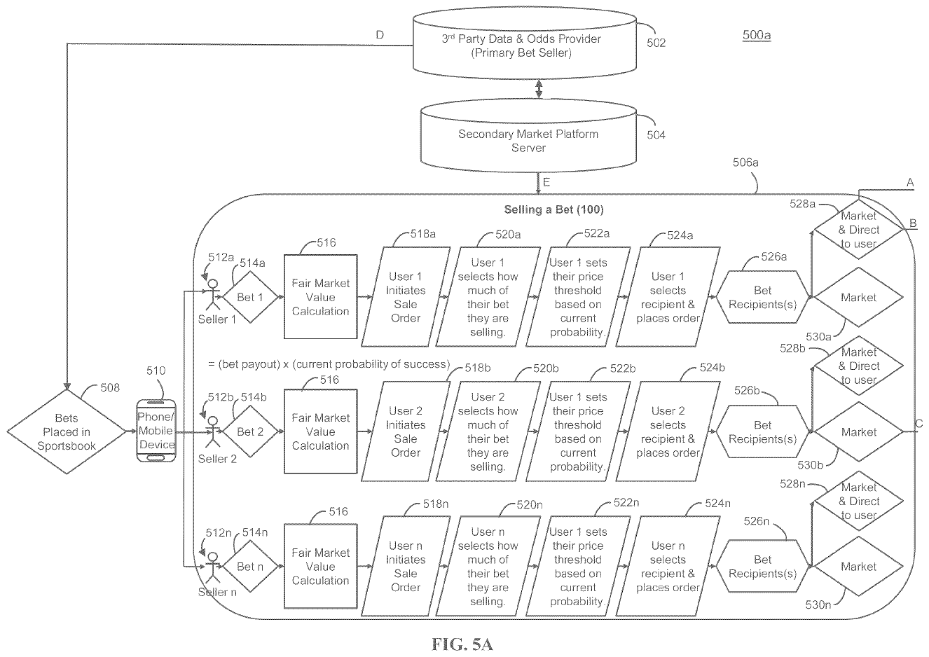

With regard to FIG. 3C, a screen shot of a user interface 300c may be configured to enable a user to set ranges for buying and selling individual bets into a secondary market is shown. The ranges may be set via a user interface element 342 with adjustable low and high adjustment features 344a and 344b that allow users to selectably specify acceptable estimated winning percentages (or other parameter(s)) for a transaction to be activated or enabled to be potentially automatically conducted (i.e., bet made available for a sport bettor buyer to purchase the bet being sold into the secondary market). In an embodiment, rather than using estimated win percentages for the ranges, a price range for activating the transactions may be used to cause the bet to be automatically made available for purchase when the bet value falls within the defined price range or minimum return 346a and maximum return 346b (collectively 346). Rather than setting the range using the user interface element 342, the range may be set by entering the minimum and maximum returns 346 in text entry fields or other user interface control features. For example, the sale range may be set using text entry fields, control features, such as sliders, or any other user interface features. The wider the range, the more likely a sale will occur because the estimated win percent is more likely to fall within the range, the smaller the range, the less likely a sale will occur because the estimated win percent is less likely to fall within the range. When a winning percent (or other parameter) of the bet outcome is within the set range, the bet may be placed onto or added to a consolidated sale liquidity ledger (see FIG. 4) to be made available for purchase (i.e., if not within the set range, then the bet remains in the consolidated sale liquidity pool, but not available for purchase because the condition for the sale has not been met).

As with FIG. 3B, the user interface of FIG. 3C may have the bottom portion 324 change while the top portion 322 remains the same. As shown, the current estimated win percentage is about 35% (“~35%”), which is out of range set by the sports bettor, which means the bet being sold will not immediately sell with the current sale range, but may sell as market conditions change (e.g., the estimated winning percent or probability changes to be within the set range). The sports bettor may have the option to adjust the sale range adjustment feature 344a to cause the lower win percentage to be equal to or lower than 35%. Alternative user interface features may be utilized in accordance with the principles described herein. Once the price range is set, the sports bettor selling the bet may select a “Select Opponent” button 348 or cancel the sale by selecting a “Cancel” button 350.

With regard to FIG. 3D, a screen shot of a user interface 300d that lists consolidated sale liquidity ledgers 352a, 352b, . . . 352n (collectively 352), which represent at least a fraction of bets that are in corresponding consolidated sale liquidity pools that are actively available for sale, as further described herein, associated with respective bet outcomes 354a-354n (collectively 354) with bets currently being offered for sale is shown. The bet outcomes 354 may be a “Parlay,” “Single Leg,”. . . “2 Leg Parlay,” etc. It should be understood that many different bet outcomes may be available for the same or different sports, as understood in the art. The bet outcomes 354 may include associated detailed information 356 a-356n (collectively 356) of the outcomes, including “Celtics-7.5, Jaylen Brown Under 30.5 pts, Jayson Tatum over 26.5 points,” “Cleveland Brown+4.5,” “LA Dodgers ML, Red Sox vs. Yankees O/U 6.5.” Each of the listed consolidated sale liquidity ledgers 352 may list respective odds 358a-358n (collectively 358) along with respective live odds 360a-360n (collectively 360). Also listed with each of the listed consolidated sale liquidity ledgers 352 may be a currently available bets 362a-362n (collectively 362), (e.g., $525, $99, $2,690), along with a total amount to win 364a-364n (collectively 364) if the total currently available bets 326 are purchased and win. Win percent 366a-366n (collectively 366) may also be listed to inform a potential sports bettor buyer what the chance of winning the respective bet outcomes 354. For each of the available consolidated sale liquidity ledgers 352, the currently available 362 represents a total of one or more bets or fractions thereof that have been placed into the respective consolidated sale liquidity ledgers 352 to enable the owner(s) of the bets to hedge their bets, which generally more likely to occur if there is a positive change in the odds of the bet dropping so that there is a higher chance of the bet winning. The bets may be sold at any time prior to or during a corresponding sports event, and the odds or win percent 366 of winning may change dynamically based on many different factors as set by a book.

The sports bettor buyers may select a respective “Watchlist” button 368a-368n (collectively 368) to add the particular bet outcome to a watch list or a “Quick Buy” button 370 a-370n (collectively 370) to purchase from the respective consolidated sale liquidity ledgers 352. The buyer may elect to purchase any amount of a ledger ranging from $1 to the amount currently available 362. If the sports bettor buyer elects to purchase by selecting one of the “Quick Buy” buttons 370, a “Quick Bet” user interface, such as shown in FIG. 3E, may be displayed.

It should be understood that additional and/or alternative information may be included, as well. For example, and as further shown, multiple tabs 372, including a “Live” tab, “Not Started” tab, and “Futures” tab may be available for a user to select to view different available consolidated sale liquidity ledgers in each status of games (i.e., Live, Not Started, and Futures). Also selectably available are icons 374, including “Marketplace,” “My Bets,” and “My Orders” to enable the sports bettor to manage (i.e., buy new, sell existing, hold existing) his or her portfolio of sports bets. In an embodiment, a data object that includes these and other data elements may be utilized to manage bets within the secondary market platform and optionally communicate with a primary betting platform from which a user has made or purchased bets.

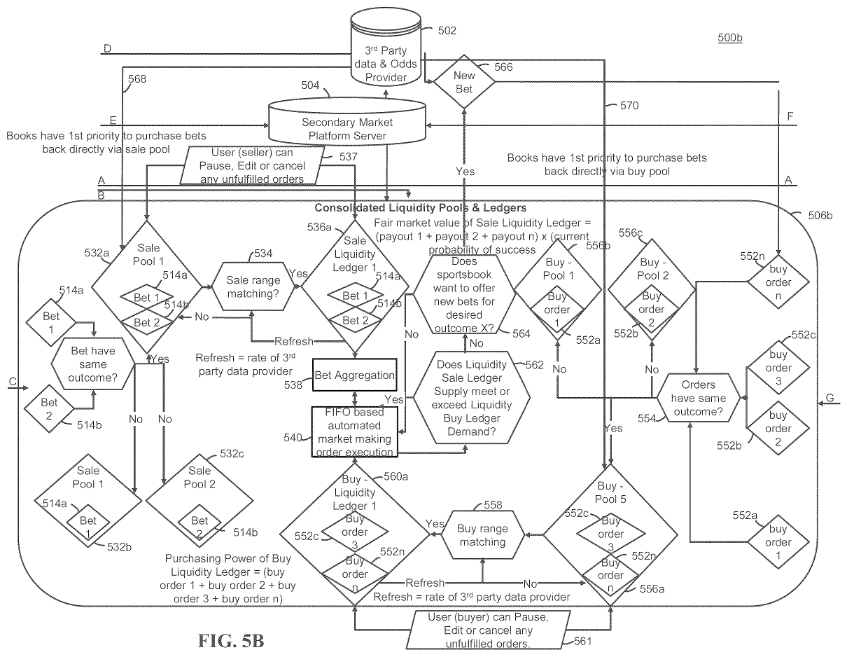

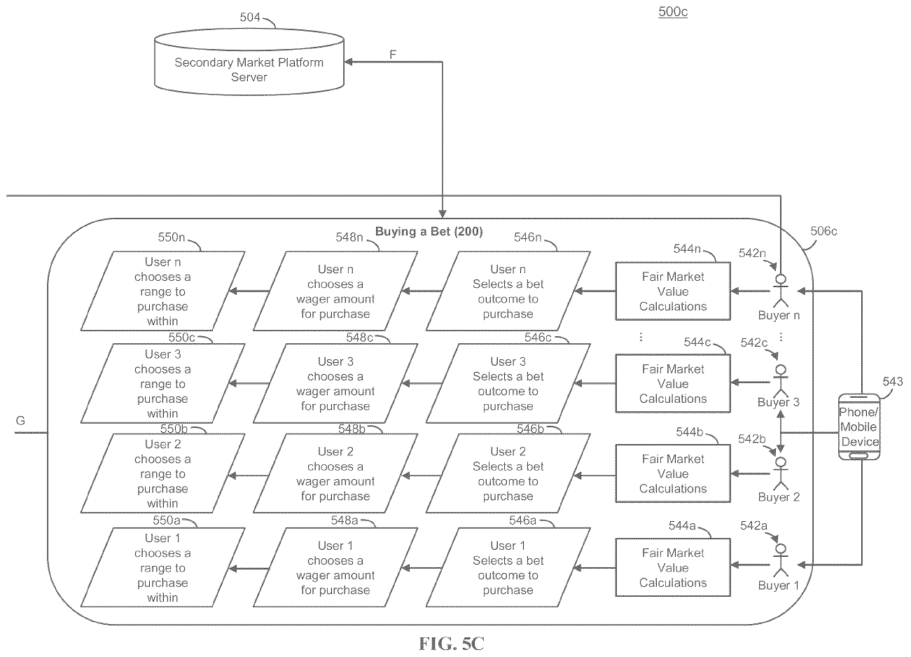

With regard to FIG. 3E, a screen shot of a user interface 300e that enables a user to purchase bets or portions thereof from one or more of the consolidated sale liquidity ledger(s) 352 of FIG. 3D is shown. The user interface 300e enables the user to buy a bet of a certain amount from a selected consolidated sale liquidity ledger, in this case consolidated sale liquidity ledger 352a, after the user selects a bet for purchase. In an embodiment, if the consolidated sale liquidity ledger 352a does not have sufficient bets being requested that are currently available bets 362a (e.g., a sports bettor buyer wants to purchase in excess of $252 from the consolidated sale liquidity ledger 352a when the currently available is $252), a sports betting platform (e.g., one of the sports betting platforms 206 of FIG. 2B) may cover the shortfall (e.g., $48 of the bet outcome 354a if a $300 purchase request of the bet outcome 354a is requested from the consolidated sale liquidity ledger 352a). If the sports betting platform is unable or unwilling to supplement a difference between the purchase request and the currently available bets 362a, then the secondary market platform may fulfill the buy order and allow the remainder of the buy order to remain in the consolidated buy liquidity ledger, as further provided in FIG. 5B. In an alternative embodiment, rather than the sports betting platform 206 covering the shortage of the bet purchase request, the bet purchase request may be placed into a queue to wait for additional bets to be added to the consolidated sale liquidity ledger 352a for the bet outcome 354a until the bet purchase request is fulfilled. That is, if one consolidated sale liquidity ledger does not have sufficient liquidity (i.e., enough bets to fulfill a purchase order), then if the user wants to purchase the same outcome, the user has to wait for another user to submit a bid or portion thereof of the same outcome into the consolidated sale liquidity ledger with that outcome. Otherwise, the user has to purchase from a different consolidated sale liquidity ledger (e.g., consolidated sale liquidity ledger 352b) with a different outcome (e.g., bet outcome 354b).

As an example, if there was a bet outcome on the “Cleveland Browns+4.5,” there would be a single consolidated sale liquidity pool (and a sale ledger if any of the bets in the pool meet a sale range condition) on the sale side once a sports bettor buyer sells the first “Cleveland Browns+4.5” bet. By the same token, on the buy side, there would be a single consolidated buy liquidity pool (and a buy ledger if any of the buy offers in the pool meet a buy range condition) (see FIG. 4) for the buy orders with the same bet outcomes once that first sports bettor buyer creates an order to purchase ‘Celtics to win outright’ action. The sales of the sports bets into the consolidated sale liquidity ledgers 352 via the secondary market platform 212 of FIG. 2B, no matter what the original purchase odds were from a sports betting platform 206, are placed into a common consolidated sale liquidity pool of the respective bet outcome, thereby simplifying the buy and sell process while enabling the users to determine a desired level of hedge for each of the bet. By simplifying the buy and sell process of sports bets via the consolidated sale liquidity pools and corresponding consolidated sale liquidity ledgers 352 (and corresponding consolidated buy liquidity pools and ledgers), electrical energy in performing processing and communications in performing transactions may be reduced.

Still yet, the secondary market platform 212 may be linked with a sportsbook or other third-party platform with which users have an available cash balance to place bets. The secondary market platform 212 via a user interface may allow users to partition out a certain amount of the available cash balance that is available to place buy orders via the secondary market platform 212. Being able to access and identify the available cash balance allows users to place multiple orders via the secondary market platform 212 to purchase portions of or all of available balance (e.g., those that meet sale conditions) of bids within a consolidated sale liquidity pool without exceeding an allotted amount. For example, if a user has $1,000 in their account of a sports betting platform, the user may allot $500 to their balance or account via the balance with the secondary market platform 212. By allotting a certain amount, a sports bettor may place multiple buy orders for up to $500 each. However, the orders stop filling once any combination of the outstanding orders have been filled up to the allotted $500 for each.

As shown in FIG. 3E, a user interface 376 for purchasing a desired dollar value of consolidated bets in the consolidated sale liquidity ledger 352a for the bet outcome 354a of “3 Leg Parlay” is shown. The user interface may include a text entry field in which a sports bettor may enter a purchase amount 378 (e.g., $20) of the consolidated bets to purchase. Market value 380 (e.g., $44.45) may be displayed for the sports bettor to see. A user interface feature 382, such as a slide feature, that provides a lower range control element 384a and upper range control element 384b may enable the sports bettor with the ability to set a range or condition within which a purchase may be automatically or semi-automatically be conducted if the win percent, odds, or other parameter occurs in the market based on a variety of factors (e.g., score during a game, health of player(s), weather conditions, etc.). A range of odds of winning (estimated winning %) a bet of the bet outcome 354a of the consolidated sale liquidity ledger 352a may be set by the sports bettor wanting to purchase a purchase amount 378 from the consolidated sale liquidity ledger 352a. Alternative parameters may be used for ranges, and alternative user interface elements may be made available to enable setting the buying range.

The purchase amount 378 may reduce the total currently available amount 362a of the consolidated sale liquidity ledger 352a, but if a transaction does not occur due to not being within the buying range, then other purchased amounts by other sports bettors that do occur may reduce the ability for the sports bettor of the instant purchase request to not be able to make a purchase unless a sport betting platform covers such purchases when the consolidated sale liquidity ledger 352a becomes sold out. When a winning percent (or other parameter) of the bet outcome is within the set range, the purchase amount 378 may be placed onto a consolidated purchase liquidity ledger (see FIG. 4) to be made available to purchase (i.e., if not within the set range, then the purchase amount 378 remains in the consolidated buy liquidity pool, and a sale does not occur because the range condition is not met by the estimated win percent or there are no bets available for that sports bettor). By providing consolidated sale and purchase liquidity pools to sell and purchase bets, efficiency of selling and buying bets and portions of bets of common outcomes may be provided, and computing and communications efficiencies that result in the consolidation of the sports bets are also achieved.

Maximum profit 386a and minimum profit 386b (collectively 386) may be displayed based on the purchase amount 378 and odds within the buying range 384a and 384b. Also shown is the currently available amount 362a of bets placed into the consolidated sale liquidity ledger 352a and a total amount to win 364a based on the current win percent 366a. Minimum win percent 388 a and maximum win percent 388b (collectively 388) may be displayed based on the set range using the user interface feature 382. Once the sports bettor buyer completes entering the purchase amount 378 and set the minimum and maximum win percentages 388, the user may select a “Confirm” button 389 to submit the purchase order into a consolidated buy liquidity pool.

The design elements shown in the user interfaces 300 of FIGS. 3A-3E include clear options for selecting percentages and entering specific amounts, thereby making the user interface user-friendly, intuitive, and efficient for managing bet transactions on a secondary market for hedging existing bets. Overall, the user interfaces are designed to provide flexibility and efficiency in managing bet transactions, with features that support partial sales, range settings, and parlay management. Although the secondary market platform may be configured with consolidated sale liquidity ledgers 352, it may be possible to further enable buyers of existing bids to purchase directly from sellers, although such buying and selling is generally considered to be less efficient because listings of existing bets may be significantly more numerous than a listing of the consolidated sale liquidity ledgers 352.

With regard to FIG. 4, a network environment 400 in which a secondary market platform 402 for supporting buying and selling of sports bets using consolidated liquidity pools and consolidated liquidity ledgers is shown. In an embodiment, the secondary market platform 402 may include one or more secondary market platform servers 404 to support sports betting hedging and/or a sports betting derivative market, as described herein. In an alternative embodiment, rather than the second market platform server(s) 404 being independent server(s), software of the server(s) 404 that performs the functionality of the secondary market platform 402 may be integrated into one or more servers of a primary bet seller or platform 406. It should be understood that each of the systems, servers, devices, and so on may include one or more processors, non-transitory memory, communications devices (e.g., input/output unit that communicate data over communications networks in any format and communications protocol), and so on to support the functions described herein, as understood in the art. The processors may be programmed to manage object-oriented data structures to manage data of bets, sell orders, buy orders, queues (e.g., first-in/first-out queues), and so on. The servers 404 may have one or more processors that operate to perform the functionality described herein (see, for example, FIGS. 5A-5C).

The consolidated liquidity pools of the secondary market platform 402 may include consolidated sale liquidity pools 408a and consolidated buy liquidity pools 408b (collectively 408), and the consolidated liquidity ledgers may include consolidated sale liquidity ledgers 410a and consolidated buy liquidity ledger 410b (collectively 410). The pools 408 and ledgers 410 may be in communication with the secondary market platform server(s) 404 for supporting buying and selling of existing initial bet(s) 412a that were purchased by sports bettors from the sports betting platform 404 and sold on the secondary market platform 402 as hedge bet(s) 412b (all or fractions of the initial bet(s) 412a) and initially placed in the consolidated sale liquidity pools 408a via the secondary market platform server 404.

In summary, the network environment 400 is shown to include a primary bet seller or platform 406, which may be considered a third-party data and odds provider, and that may create and sell sports bets 104. Three core functions of the secondary market platform 404, including enabling sports bettors to sell hedge bets 412b, operating the consolidated sale and buy liquidity pools 408, operating the consolidated sale and buy liquidity ledgers 410, and enabling sports bettors to buy bets 414 by submitting bet orders are shown. In an embodiment, the primary bet platform 402 may communicate directly with the pools 408 and/or secondary market platform server 404 to enable the primary bet platform 406 to sell and purchase bets 404 sold via the secondary market platform 402 with priority in a FIFO queue. The different functions are high-level functions, and it should be understood that other high-level and/or lower-level functions may be provided and executed by one or more processors. For example, functions that enable communicating with one or more primary sports betting platforms or electronic wallets or other data repositories in which the purchased bets 404 of the sports bettors may be stored for selling some or all of a hedge bet 412b, as further described herein.

The consolidated liquidity pools 408 may be dynamically created in response to receiving a first instance of a hedge bet 412b to be sold into the consolidated sale liquidity pool 408 having a bet outcome that matches the hedge bet 412b. Thereafter, any additional bets that match the bet outcome of the first instance of the hedge bet 412b may be added to the consolidated sale liquidity pool 408a that matches the same bet outcome as the first instance. In an embodiment, each of the consolidated liquidity pools 408 and 410 may be configured as first in, first out pools, and each of the hedge bets 412b (e.g., data objects in which the hedge bets 412b are included along with a variety of other data and/or metadata) may be indexed such that the hedge bets 412b that are purchased from the consolidated sale liquidity pools 408a may be tracked and managed in a manner that enables simultaneous acquisition of multiple hedge bets 412b (or fractions of one or more hedge bets 412b) from different sports bettors. For example, if a consolidated sale liquidity pool with a particular bet outcome (e.g., “Over 56 Points”) has a total value of hedge bets 412b of $100 with an average value of $20 from each of five hedge bets 412b, then a buyer from the pool may purchase all of the hedge bets 412b or a portion of the hedge bets 412b that may or may not include a full amount of each of the hedge bets 412b (e.g., one full bet and half of another bet because of the purchase amount and position of the bet amounts of the different bets in the FIFO of a consolidated sale liquidity ledger) that are in the consolidated sale liquidity pool.

In an embodiment, a new bet 416 may be automatically created by the primary bet seller 406 in the event that a sports bettor submits to buy at least a fraction of a hedge bet 412b as a purchase hedge bet 414 that is higher than a currently available amount in one of the consolidated sale liquidity pools 408a (or corresponding consolidated sale liquidity ledgers 410a). The new bet 416 may be for the same event and have the same bet outcome as the sports bettor is seeking to buy.

With regard to FIGS. 5A-5C, flow diagrams of illustrative processes 500a-500c (collectively 500) for supporting the secondary market platform for buying and selling sports bets using consolidated liquidity pools are shown. As shown, a primary bet seller platform 502 (third party data and odds provider) and a secondary market platform server 504 may be in communication with one another to enable communications via an API or otherwise for efficiency. The secondary market platform server 504 may be configured to support a secondary market platform composed of a selling a bet process 506a, consolidated liquidity pools in ledgers process 506b, and buying a bet process 506c (collectively 506). It should be understood that the primary bet seller platform 502 may include one or more servers configured to sell original sports bets, as previously described.

The process 500a may start at step 508, where bets may be placed (or purchased) with a sports book or primary bet seller 502. The bets may be made with the primary bet seller 502 using an electronic device 510, such as a smart phone, mobile device, desktop device, or any other electronic device that may be in communication with the primary bet seller 502. Sports bettors 512a-512n (collectively 512) who placed existing bets may sell hedge bets 514a-514n (collectively 514), which may be a portion or an entirety of the initial bets into consolidated sale liquidity pools (408a of FIG. 4). In selling the hedge bets 514, a fair market value calculation engine 516 may be utilized to determine fair market value of each of the respective initial bets and/or hedge bets 514. In an embodiment, the fair market value calculation may be calculated by using a fair market value equation, such as bet payout multiplied by current probability of success (FMV=bet payout×current probability of success). The fair market value may be displayed on the user interface, as previously shown in user interface 300a of FIG. 3A.

At steps 520a-520n (collectively 520), each of the sports bettors 512 may select how much of the respective initial bets that the sports bettors 512 are offering for sale as the hedge bets 514. The hedge bets 514 may be a percentage selected from a list of standard percentages, such as 25%, 50%, 75%, 100%, of respective initial bets, but may alternatively be any percentage or value of the total of the initial bets. For example, the amount of the hedge bets 514 may range from one dollar (or lower) to an entirety of the entire initial bets, such as shown in FIG. 3B. At steps 522a-522n (collectively 522), the sports bettors 512 may set their price sale range 344 based on current probability, such as shown in FIG. 3C. It should be understood that the order of the steps of the process 506a may be altered, and that additional and/or alternative steps may be utilized. At steps 524a-524n (collectively 524), the sports bettors 512 may select recipients in placing the orders to sell the respective hedge bets 514. The recipients may be (i) direct to another user and into the secondary market via the second market platform server 504 (whichever is sold first gets the bet) or (i) only into a secondary market. Alternative options may be possible. At steps 526a-526n (collectively 526), in response to the respective sports bettors 512 selecting recipients, the process 500a may route the hedge bets 514 into the secondary market and directly to users at steps 528a-528n (collectively 528) or limited to the secondary market at steps 530a-530n (collectively 530).

Referring to FIG. 5B, if the hedge bets 514 are to be offered to both the secondary market and directly to other sports bettors seeking to purchase the bets 514, then the hedge bets 514 may follow paths A and B. As shown, at step 531, a determination may be made to determine whether bets 514a and 514b have the same bet outcome. If so, then the hedge bets 514 may be placed into a consolidated liquidity pool 532a. It should be understood that an unlimited number of hedge bets 514 for an unlimited amount of bet value may be placed into each of the consolidated sale liquidity pools 532. If the determination at step 531 is that the bets do not have the same bet outcome, then the hedge bets 514a and 514b may be placed into different consolidated sale liquidity pools 532b and 532c. Each of the consolidated sale liquidity pools 532a-532c (collectively 532) may be configured with a FIFO structure such that hedge bets 514 that are placed or listed therein may be sold in a time-sequential, first-in, first-out manner, as previously described. It should be understood that if the hedge bets 514 have different bet outcomes, that many other consolidated sale liquidity pools beyond those shown may be established and operated prior to and during an event associated with the hedge bets 514. Once the event associated with the hedge bets 514 has concluded, the secondary market platform server 504 may settle the hedge bets 514 and close each of the pools 532. A history of the 532 may be stored for auditing or other purposes.

At step 534, a determination may be made as to whether any of the hedge bets 514a and 514b in the consolidated liquidity pool 532a matches a sell range. The sell range may be set by the sports bettors 512 using the user interface 300c of FIG. 3C, for example. The sell range matching may be made based on a current win probability of the bet outcome associated with the consolidated sale liquidity pool 532a. If the current win percent is within a sell matching range of one or more of the hedge bets 514a and 514b, then the one or more hedge bets 514a and 514b may be placed into or listed on a consolidated sale liquidity ledger 536a. It should be understood that other consolidated sale liquidity ledgers (not shown, but could be consolidated sale liquidity ledger 536b-536n) may be established if sell ranges of the hedge bets 514 in consolidated sale liquidity pools 532 have ranges that match a current win probability. If a determination that no hedge bets 514a or 514b have sell matching ranges that match the current win probability of the bet outcome at step 534, then the process 500b may continue to repeat looping steps 532a and 534 to continue determining whether or not to move the hedge bets 514a and/or 514b.

The process may continue to repeat steps 532a and 534 until the consolidated sale liquidity pool 532a is terminated due to the event associated with the pool 532a being completed or the sports bettors 512 change their hedge bets 514a and/or 514b, as further described herein. Although not shown, decision blocks that perform the same or similar function as step 534 may be utilized in conjunction with consolidated sale liquidity pools 532b and 532c. Such processes are omitted herein for simplification purposes. In an embodiment, at step 537, the sports bettors 512 may be provided with the ability to pause, edit, or cancel any unfulfilled sale orders currently positioned in either or both of the consolidated sale liquidity pools 532 and consolidated sale liquidity ledgers 536. Depending on a configuration of the pools 532 and ledgers 536, software may be configured to either remove the hedge bets 514 or simply mark parameter(s) of the bets 514 to alter (i.e., pause, edit, or cancel) the hedge bets 514.

The consolidated sale liquidity ledger 536a may be used to index and make available bets, such as hedge bets 514a and 514b, that are determined to match the sale range set by the respective sports bettors 512, in this case sports bettors 512a and 512b. In the event that the sell range of one or more of the hedge bets 514a and 514b in the consolidated sale liquidity ledger 536a no longer matches the real-time value (i.e., the real-time value is no longer in the sell range of at least one of the associated hedge bets 514a and 514b), then the process 500b may return or de-index the one or more hedge bets 514a and 514b that do(es) not match so that hedge bet(s) 514a and 514b remain indexed in the proper FIFO order in the consolidated sale liquidity pool 532a. In being de-indexed, the hedge bet(s) 514a and 514b are no longer available to be purchased on the secondary market platform.

A refresh rate for determining matching may be based on a third-party data provider, such as the primary bet seller 502, feeding or updating real-time odds data associated with the bet outcome of the consolidated sale liquidity ledger 536a and consolidated sale liquidity pool 532a. A fair market value of the consolidated sale liquidity ledger may be calculated by: a summation of (i) payout of bet 1, (ii) payout of bet 2, . . . (n) payout of bet n and multiplied by current probability of success. As such, sports bettors who purchase from the consolidated sale liquidity ledger 536a may pay fair market value for the bets being offered for sale. It should be understood that sports bettors who want to purchase the consolidated hedge bets 514 being offered for sale via the consolidated sale liquidity pool 532a may only purchase the bets that are placed or indexed into the consolidated sale liquidity ledger 536a as the real-time odds of winning (estimated winning %) or return value match a set range for winning odds or return value of those bets established by the sports bettors 512 of the bets, in this case hedge bets 514a and 514b.

At step 538, the hedge bets 514a and 514b stored on the consolidated sale liquidity ledger 536a may be aggregated for display on a user interface, such as user interface 300d of FIG. 3D (e.g. “currently available” 362a). A FIFO-based automated market-making order execution module 540 may be configured to manage sales of the hedge bets 514a and 514b listed and indexed on the consolidated sale liquidity ledger 536a. The module 540 may receive offers or buy orders, as described hereinbelow, to buy a certain amount of the aggregation of the bets as performed by step 538, and handle purchasing of the entirety of the hedge bets 514a and 514b or portions thereof listed in the ledger 536a. In being indexed in the consolidated sale liquidity ledger 536a, bets 514 that are first listed in the consolidated sale liquidity pool 532a may be indexed with the same time-sequenced order even if indexed in the ledger 536a due to a matching range being different than other hedge bets 514 already indexed in the ledger 536a so that priority of listing hedge bets 514 in the pools remains throughout the sales process of the secondary market. Alternatively, indexing in the ledgers 536 may operate by time that the hedge bets 514 are listed in the ledgers 536 to allow for the range set by the sports bettors 512 to factor into priority of sale of the hedge bets 514 in addition to time of initiating the sale process.

Turning to FIG. 5C, the process 500c may be used to manage sports bettors 542a-542n (collectively 542) seeking to purchase bets from the consolidated sale liquidity pools 532 (via corresponding consolidated sale liquidity ledgers 536, as previously described). The sports bettors 542 may use respective electronic devices 543 to engage the user interfaces 300d and 300e of FIGS. 3D and 3E of the secondary market platform supported by the secondary market platform server 504 that supports the process 506c for buying a bet. The process 506c may perform fair market value calculations 544a-544n (collective 544) for each of the respective sports bettors 542 seeking to buy hedge bets 514 via the secondary market platform. The fair market value calculations 544 may be performed for bet outcomes associated with the consolidated sale liquidity pools 532 for display to the respective sports bettors 542 on the user interfaces 300d and 300e, for example.

As steps 546a-546n (collectively 546), the sports bettors 542 may select a bet outcome from a list of the available consolidated sale liquidity pools 532 to purchase via a user interface, such as user interface 300d of FIG. 3D. Once selected, the sports bettors 542 may choose a wager amount to purchase. The wager amount may be of any value, including higher than the currently available value of the pool, which means that an unfilled amount may be filled in the future or the bet seller platform 502 may sell a bet to the buyer. As with the sale side, the buy side of the hedge bets 514 from the consolidated sale liquidity pools 532 (via the consolidated sale liquidity ledgers 536), sports bettors 542 may have orders fulfilled in a FIFO manner. If a sports bettor chooses a wager amount less than the currently available value, then if the hedge bets 514 meet the sale range, the purchase transaction may be performed immediately. However, if the wager amount is higher than the currently available value, then the currently available value may be purchased in full, and then the remaining unfilled value may remain pending until additional hedge bets 514 with the bet outcome are added to the respective consolidated sale liquidity ledger, such as ledger 536a, and that meet a buy range of the sports bettor are added or the seller platform 502 fulfilling the buy request with a new bet, for example.

In response to the sports bettors 542 completing respective sports bet submission processes for purchasing the hedge bets 514 as aggregated in the consolidated sale liquidity pools 532, individual buy orders 552a-552n (collectively 552) may be generated. The buy orders 552 may be received simultaneously or non-simultaneously. At step 554, a determination may be made as to whether any of the buy orders 552 have the same bet outcomes. If a determination at step 554 is made that the any of the buy orders 552 have the same bet outcomes, then the buy orders 552c and 552d with the same bet outcomes may be placed or listed in a consolidated buy liquidity pool 556a. If a determination at step 554 is made that the buy orders 552 do not have the same bet outcomes, then new consolidated buy liquidity pools 556b and 556c may be formed in which buy orders 552a and 552b may be respectively placed.

The consolidated buy liquidity buy pools 556a, 556b, and 556c (collectively 556) are independent pools as a result of the bet outcomes being different from one another so as to be applied to purchasing hedge bets 514 that are initially listed in consolidated sale liquidity pools 532a. It should be understood that as additional buy orders are received from the sports bettors 542, that (i) the additional buy orders 552 may be added to the consolidated buy liquidity pools 556 if the additional buy orders have the same bet outcomes as existing consolidated buy liquidity pools 556, or (ii) new consolidated buy liquidity pools may be created if different bet outcomes are requested by the sports bettors 542. As hedge bets 514 (or portions thereof) with different bet outcomes are being offered for sale by the sports bettors 512 and corresponding consolidated sale liquidity pools 532 are created, then the user interface 300d may display and make available those consolidated sale liquidity pools 532 for the sports bettors 542 to purchase.

As with the consolidated sale liquidity pools 532 have corresponding consolidated sale liquidity ledgers 536 created to contain hedge bets 514, in this case hedge bets 514a and 514b, that match a sell range, the consolidated buy liquidity pools 556 may have consolidated buy liquidity ledgers established for the buy orders 552 to be listed thereon To create a consolidated buy liquidity ledger, a decision block at step 558 may determine whether current win probability is within a buy range (e.g., minimum win percent and maximum percent, which correspond to minimum profit and maximum profit) set by a sports bettor via the user interface 300e. If the determination of step 558 is yes, then the process creates a consolidated buy liquidity ledger 560a that includes or indexes both the buy orders 552c and 552n. It should be understood that the buy orders 552c and 552n may have different ranges, so it is possible for one or both to be added to the consolidated buy liquidity ledger 560a depending on the current win probability. As with the sale ledgers 536, the buy ledgers 560 may use a FIFO architecture, where the buy orders 552 may be indexed by submission time of the buy orders 552 or by time the buy orders 552 were added to the ledgers 560.

The process 500b may provide for automatic, real-time or non-real-time (e.g., event driven) updates that update the consolidated buy liquidity pools 556 and consolidated buy liquidity ledgers 560a (and others should others exist) to cause the buy orders 552 to be move in and out of the consolidated buy liquidity ledgers based on the current win probability. For example, if the current win probability changes for a particular bet outcome, then the buy order(s) 552 within the consolidated buy liquidity ledger 560a and pool 556a may be updated. The consolidate buy liquidity ledger 560a including buy orders 552c and 552n has a purchasing power or aggregate value of buy orders 552c and 552n. As with the consolidated sale liquidity ledger 536a, the consolidated buy liquidity ledger 560a may be configured using a FIFO structure such that the earliest buy orders 552 in the ledger 560a may be fulfilled first, thereby motivating the sports bettors 542 to submit purchase orders early. Such motivation on both the sale and buy side helps to create a more vibrant marketplace and also helps to reduce both energy consumption and communications because of the consolidation of the sale and buy sides. In an embodiment, at step 561, the sports bettors 542 may be provided with the ability to pause, edit, or cancel any unfulfilled buy orders currently positioned in either or both of the consolidated buy liquidity pools 556 and consolidated buy liquidity ledgers 560. Depending on a configuration of the pools 556 and ledgers 560, software may be configured to either remove the buy orders 552 or simply mark parameter(s) of the buy orders 552 to alter (i.e., pause, edit, or cancel) the buy orders 552.

Continuing with the FIFO-based automated market-making order execution module 540, in response to the consolidated buy liquidity ledger 560a being updated, consolidated sale liquidity ledger 536, winning percent changing, or otherwise, the module 540 may execute (or continue to execute) to initiate a sale of consolidated hedge bet(s) 514 from the ledger 536a to consolidated buy order(s) 552 from the ledger 560a. The process 506b may continue at step 562, where a determination may be made as to whether the bet aggregation of step 538 is indicative of the consolidated sale liquidity ledger 536a meeting or exceeding demand in the consolidated buy liquidity ledger 560a. If so, then the process 506b may return to the module 540 for one or more buy orders 552 to be executed in purchasing the aggregated bids listed in the ledger 536a. Otherwise, if at step 562 a determination is made that that the bet aggregated of step 538 indicates that the consolidate sale liquidity ledger 536a does not meet or exceed demand in the consolidated buy liquidity ledger 560a, then the process 506b may continue to step 564, where a determination may be made as to whether the sportsbook or primary bet seller 502 wants to offer new bets 514 for the bet outcome. In an embodiment, the primary bet seller 502 may establish a parameter with the secondary market platform to cause the determination at step 564 to be YES or TRUE. If the primary bet seller 502 wants to offer new bets for the bet outcome of the consolidated buy aggregated pool 556a and corresponding ledger 560a, then the process 506b may continue at step 566, which may offer a new bet prior to continuing to the buy order 552n. In other words, if the primary bet seller or sportsbook 502 wants to offer the same bet outcome for which there are currently buy orders in the consolidated buy ledger 560a in the market, then those buy orders 552 may be filled as new bets directly from the primary bet seller or sportsbook 502 as oppose to filling in the market and purchasing action from another one of the sports bettors 512 who place existing bets into the consolidated sale liquidity pools 532. Otherwise, if the determination at step 564 is NO, then the process 506b may continue to step 540 for the transaction to be completed and no further action to be taken until additional bets are added to the ledger 536a.

As previously described, the primary bet seller 502 may be provided with the ability to sell and buy bets with priority over the sports bettors 512 and 542. Such buy and sell priority is shown as direct communications with the consolidated sell aggregated pools 532 and consolidated buy aggregated pools 556 via respective communications channels 568 and 570. In either case, the bet(s) sold by the primary bet seller and buy orders requested by the primary bet seller may be placed in a first position in the pools 532 and 556 of the secondary market platform. That is, if the primary bet seller or sportsbook 502 wants to participate in the market as either a buyer or seller, the orders of the primary bet seller 502 may be given priority in the queue and automatically given priority to fill over buy/sell orders placed by individual sports bettors 512 and 542.

As previously described, pools are created based on user-driven actions when sports bettors sell bets purchased from primary sports betting platform(s). The system supports user-driven creation of liquidity pools, as opposed to system or “house” driven pools by being dynamically created when a user sells a first instance of a bet on the platform. That is, the first person to sell a specific bet outcome initiates a liquidity pool for that bet. Each consolidated liquidity pool corresponds to a unique bet outcome, such as over/under 55 points in a game. If multiple users sell bets with the same outcome, the bets from each of the users are aggregated into the same pool. The pools are created based on the bet outcomes available on respective sportsbook platforms, where each sportsbook platform may have an associated set of consolidated liquidity pools (as opposed to intermixing bets from different sportsbooks into common consolidated liquidity pools since the different platforms may have different constraints). The system ensures that bets with the same parameters are grouped together, thereby enabling simultaneous and efficient purchasing of bets associated with the respective consolidated liquidity pools, and indexing of the bets in a first in, first out manner supports efficient management of the bets in the pools. As more users sell bets with the same outcome, the pool grows dynamically, thereby allowing buyers to purchase portions of the aggregated bets in a real-time manner. Overall, pools are created dynamically based on user actions and are aggregated to reflect the same bet outcomes, thereby ensuring efficient and fair market transactions.

Although the principles described herein are focused on sports for bets and hedging thereof, it should be understood that other events in which bets are placed may be considered to be supported using the principles described herein. For example, betting for political elections may be hedged utilizing the principles described herein, and for the purposes of this disclosure, the term sports bets may incorporate events other than sports per se.

### Features

One embodiment of a computer-implemented method may include receiving, by at least one processor from a first client device, a first data object including data associated with a first sports bet owned by a first sports bettor as made on a sports event, the data including (i) a first sports event identifier, (ii) a first bet outcome identifier, and (iii) a first hedge bet value less than or equal to a bet value of the first sports bet, the first hedge bet value selectably made available for resale by the first sports bettor. In response to the at least one processor determining that the first data object includes a first instance of the first bet outcome identifier associated with the first sports event identifier, dynamically creating, by the at least one processor, a consolidated sale liquidity pool associated with the first sports event identifier and the first bet outcome identifier. The consolidated sale liquidity pool consolidates multiple hedge bets to optimize efficiency of energy usage and communications signals in conducting transactions of the hedge bets of the sports event. The processor(s) may first index the first data object with the consolidated sale liquidity pool. A current total sale pool value parameter may be initialized by the processor(s) to store a total sale pool value of the consolidated sale liquidity pool with the first hedge bet value. The processor(s) may communicate at least one of the first event identifier, first bet outcome identifier, and current total sale pool value to enable users of other client devices to access the consolidated sale liquidity pool via a user interface and to submit respective buy orders to buy up to the current total sale pool value. A second data object including data associated with a second sports bet owned by a second sports bettor as made on the sports event may be received by the processor(s) from a second client device. The data may include (i) the first sports event identifier, (ii) the first bet outcome identifier, and (iii) a second hedge bet value less than or equal to a bet value of the second sports bet. The second hedge bet value may be selectably made available for resale by the second sports bettor. In response to the processor(s) determining that the second sports bet includes a second instance of the first bet outcome identifier associated with the first sports event identifier, the second data object may be second indexed with the consolidated sale liquidity pool. In response to the second data object being second indexed with the consolidated sale liquidity pool, an updated current total sale pool value may be calculated by adding the second hedge bet value with the current total sale pool value. The updated current total pool value of the consolidated sale liquidity pool may be communicated by the processor(s) to enable the users of the other client devices to access the consolidated sale liquidity pool via the user interface and submit respective buy orders to buy up to the updated current total sale pool value, the buy orders being at least a fraction of the first and second hedge bet values.

Dynamically creating the consolidated sale liquidity pool may include creating a first-in, first-out (FIFO) queue that defines a listing order of the sports bets available to be conditionally purchased from the consolidated sale liquidity pool. The first and second indexing of the respective first and second data objects may include first and second indexing the first and second data objects within the FIFO queue. Receiving, by the processor(s), from the client devices, the respective data objects may further include receiving the respective data objects that each include a bet sell range specifying a lower range value and an upper range value of an estimated winning bet set by the respective first and second sports bettors. The process may further include, in response to determining that a received current estimated win percentage associated with the first bet outcome of the first sports event is between the lower and upper range values of at least one of the first and second sports bets, indexing the first and second data object(s) of which the current estimated win percentage is between the lower an upper range values on a consolidated sale liquidity ledger to enable at least a fraction of the first and/or second hedge bet values to be sold. The process may further include dynamically creating, by the processor(s), the consolidated sale liquidity ledger associated with the consolidated sale liquidity pool. dynamically creating, by the processor(s), the consolidated sale liquidity ledger may include dynamically creating the consolidated sale liquidity ledger simultaneously with dynamically creating the consolidated sale liquidity pool. In an embodiment, dynamically creating, by the processor(s), the consolidated sale liquidity ledger may include dynamically creating the consolidated sale liquidity ledger in response to determining that a first instance of the current estimated win percentage associated with the first bet outcome of the existing sports bet is between the lower and upper range values of the at least one of the first and second sports bets. In an embodiment, dynamically creating the consolidated sale liquidity ledger may include dynamically creating, by the processor(s), the consolidated sale liquidity ledger having a FIFO structure such that the hedge bet value of the at least one of the first and second sports bets indexed on the consolidated sale liquidity ledger are available for sale in time-sequential order as ordered on the corresponding consolidated sale liquidity pool.

The process may further include calculating, by the processor(s), a total sale ledger value by adding the first and/or second hedge bet value of the at least one of the first and second existing sports bets, where the total sale ledger value may be available for view by the users of the client devices in association with a listing including at least one of the event identifier and bet outcome identifier associated with the existing sports bet. In response to a portion of the total sale ledger value being purchased by a user from the consolidated sale liquidity ledger, (i) a determination as to whether the entirety of the first hedge bet value associated with the first data object is acquired, and if so, the first data object may be de-indexed from the consolidated sale liquidity ledger and the consolidated sale liquidity pool. Otherwise, if a determination that the entirety of the at least a portion of the first hedge bet value is not purchased, then: the first index of the first data object may be maintained on the consolidated sale liquidity ledger and the consolidated sale liquidity pool, and the at least a portion of the first hedge bet value of the first data object by the portion of the total sale ledger value purchased by the user may be reduced. And, (ii) in response to determining that the entirety of the at least a portion of the bet value associated with the first data object is acquired, a determination as to whether the entirety of the second hedge bet value associated with the second data object is acquired, and if so, the second data object may be de-indexed from the consolidated sale liquidity ledger and the consolidated sale liquidity pool, otherwise, if a determination that the entirety of the second hedge bet value of the second data object is not acquired, then: the second index of the second data object may be maintained on the consolidated sale liquidity ledger and the consolidated sale liquidity pool, and the at least a portion of the first hedge bet value of the second data object may be reduced by the portion of the total sale ledger value purchased by the user greater than the entirety of the first hedge bet value associated with the first data object.

Communicating, by the processor(s), the at least one of the first sports event identifier, first bet outcome, and current total sale pool value may cause a listing associated with the sports event to be accessible via a user interface by the client devices. In response to receiving a third data object including a first instance of a second bet outcome associated with the first sports event identifier that is different from the first bet outcome associated with the first sports event identifier: a second consolidated sale liquidity pool associated with the second bet outcome may be dynamically created by the processor(s), and third data object may be third indexed with the second consolidated sale liquidity pool.

The process may further include determining whether the sports event associated with the first sports event identifier has completed, and if so, the consolidated sale liquidity pool and any consolidated sale liquidity ledger associated therewith may be disabled. Otherwise, the consolidated sale liquidity pool and any consolidated sale liquidity ledger associated therewith may be maintained. In response to determining that the sports event has completed, a determination as to whether any of the first hedge bet value and second hedge bet value remains unsold, and if so, the remaining portion of the first and second hedge bet values may be applied back to the sports bets of the respective first and/or second data objects prior to the first and second sports bets being settled.

In an embodiment, the process may further include causing, by the processor(s), consolidated sale liquidity pools to be displayed on the client devices so as to be selectable by a user of a client device to purchase at least a portion of the current total pool value of a selected consolidated sale liquidity pool that includes at least two indexed data objects, thereby enabling the user to simultaneously acquire at least a portion of a plurality of existing hedge bet values from different owners of the sports bets with a single purchase.

The process may further include, in response to receiving, by the processor(s) from one of the client devices, a third data object including (i) a first instance of the first event identifier, (ii) the first bet outcome identifier, and (iii) a first buy value of a first buy order, dynamically creating, by the processor(s), a consolidated buy liquidity pool associated with the first event identifier and the first bet outcome identifier, the consolidated buy liquidity pool may consolidate sports bets to optimize efficiency of energy and communications in transactions of sports bets of sports events with common bet outcomes. The third data object may be first indexed with the consolidated buy liquidity pool. A total buy pool value parameter may be initialized, by the processor(s), to store a total buy pool value of the consolidated buy liquidity pool with the first buy value. In response to receiving, by the processor(s) from one of the client devices, a fourth data object may include (i) the first sports event identifier, (ii) the first bet outcome identifier, and (iii) a second buy value of a second buy order. In response to the processor(s) determining that the second buy order includes a second instance of the first bet outcome identifier associated with the first sports event identifier, the fourth data object may be second indexed with the consolidated buy liquidity pool. In response to the fourth data object being second indexed with the consolidated buy liquidity pool, An updated current total buy pool value may be calculated by adding the second buy value with the current total buy pool value. An automatic determination, by the processor(s), may be made as to whether any of the total sale pool value is conditionally available to be purchased with any of the current total buy pool value that is conditionally available to be used to purchase the total sale pool value, and if so, the conditionally available total sale pool value may be caused to be purchased by the conditionally available current total buy pool value.

In an embodiment, receiving, by the processor(s), from the client devices, the respective third and fourth data objects may further include receiving the third and fourth data objects that each include a buy range specifying a lower range value and an upper range value of an estimated winning bet set by respective third and fourth sports bettors. The process may further include, in response to determining that a received current estimated win percentage associated with the first bet outcome of the existing sports bet is between the lower and upper range values of at least one of the third and fourth existing sports bets, the at least one of the third and fourth data objects of which the current estimated win percentage is between the lower an upper range values may be indexed on a consolidated buy liquidity ledger to enable at least a fraction of the first and/or second hedge bet values to be bought when indexed on the consolidated sell liquidity ledger with (i) the first sports event identifier and (ii) the first bet outcome identifier.

The process may further include enabling, by the processor(s), an online sports betting platform that sold the first and second sports bets to have priority in purchasing the first and second hedge bet values of the first and second sports bets over sports bettors.

The process may further include, in response to the processor(s) determining a sports bettor seeking who submitted a buy order higher than the at least one of the first and second hedge bet values that is conditionally available for purchase, dynamically enabling, by the processor(s) to issue a new sports bet to the sports bettor who submitted the buy order higher than the at least one of the first and second hedge bet values that are conditionally available.

In yet another embodiment, a method may include receiving, by a host server from multiple client devices, multiple respective data objects including (i) an event identifier of an existing bet, (ii) a bet outcome parameter associated with the existing bet, and (iii) at least a portion of an existing bet value being made available for resale associated with the existing bet. In response to receiving a first data object including a first instance of a bet outcome parameter, dynamically creating, by the host server, a consolidated liquidity pool associated with the bet outcome parameter. A first indexing of the first data object with the consolidated liquidity pool may be performed. A total pool value parameter of the consolidated liquidity pool may be initialized using the existing bet value available for sale of the first data object. A communication, by the host server, of at least one of the event identifier, bet outcome, and total value parameters may be made to enable users of the client devices to acquire up to the total value parameter. In response to receiving, by the host server from at least one of the client devices, a second data object having a bet outcome parameter that matches the first instance of the bet outcome, a second indexing of the second data object(s) to the consolidated liquidity pool may be made. At least a portion of the existing bet value available for sale of the data object may be added to the total pool value parameter to generate a current total pool value parameter. The current total pool value parameter may be communicated by the host server to enable users of the current devices to acquire up to the current total pool value parameter.

The process may further include determining a real-time estimated win percentage of the bet outcome parameter to be met by estimating win percentage of the associated existing bet. The real-time estimated win percentage of the bet outcome to be met may be associated with the consolidated liquidity pool to be presented to users of the client devices.

First indexing and second indexing the first and second data objects may include first and second indexing the first and second data objects within a first in, first out queue. In response to a portion of the total pool value parameter being acquired by a user of the client devices from the consolidated liquidity pool, the process may (i) determine whether the entire at least a portion of the bet value associated with the first data object is acquired, and if so, removing the first index of the first data object, otherwise, maintaining the first index of the first data object and reduce the at least a portion of the existing bet value of the first data object by the portion of the total pool value parameter acquired by the user, and (ii) in response to determining that the entire at least a portion of the bet value associated with the first data object is acquired, a further determination as to whether the entire at least a portion of the bet value associated with the second data object is acquired, and if so, removing the second index of the second data object, otherwise, maintaining the second index of the second data object and reducing the at least a portion of the existing bet value of the second data object by the portion of the total pool value parameter acquired by the user greater than the entire at least a portion of the bet value associated with the first data object.

Communicating, by the host server, the at least one of the event identifier, bet outcome, and total value parameter may cause a listing to be accessible via a user interface of the client devices. In response to receiving a third data object including a first instance of a second bet outcome parameter that is different from the bet outcome parameter, dynamically creating, by the host server, a second consolidated liquidity pool associated with the second bet outcome parameter.

The process may further include determining whether the event identifier of the first data object and second data object is associated with an event that has completed, and if so, disabling the consolidated liquidity pool, otherwise, maintaining the consolidated liquidity pool. In response to determining that the event identifier of the first data object and second data object is associated with an event that has completed, determining whether any of the at least a portion of an existing bet value being made available for resale associated with the existing bet of the first data object and/or second data object, and if so, applying the any of the at least a portion of an existing bet value to a remaining portion of an existing bet value of the respective first and/or second data objects prior to the existing bet of the first and/or second data objects being settled.

The process may further include causing multiple consolidated liquidity pools to be displayed on the client devices so as to be selectable by a user of a client device to purchase at least a portion of the current total pool value parameter that includes at least two indexed data objects, thereby enabling the user to simultaneously acquire multiple existing bets from different owners of the bets with a single purchase.

One embodiment of a system may include a non-transitory memory configured to store data associated with sports bets, an input/output (I/O) unit (.e., with one or more transceiver chips), and at least one processor in communication with the non-transitory memory and I/O unit. The processor(s) configured to receive, from a first client device, a first data object including data associated with a first sports bet owned by a first sports bettor as made on a sports event. The data may include (i) a first sports event identifier, (ii) a first bet outcome identifier, and (iii) a first hedge bet value less than or equal to a bet value of the first sports bet. The first hedge bet value may selectably made available for resale by the first sports bettor. In response to determining that the first data object includes a first instance of the first bet outcome identifier associated with the first sports event identifier, the processor(s) may dynamically create a consolidated sale liquidity pool associated with the first sports event identifier and the first bet outcome identifier. The consolidated sale liquidity pool may consolidate multiple hedge bets to optimize efficiency of energy usage and communications signals in conducting transactions of the hedge bets of the sports event. The first data object may be first indexed with the consolidated sale liquidity pool. A current total sale pool value parameter may be initialized (e.g., memory address selected and optionally set to a zero value prior to other data being stored therein) to store a total sale pool value of the consolidated sale liquidity pool with the first hedge bet value. The processor(s) may communicate (optionally via the I/O unit) at least one of the first event identifier, first bet outcome identifier, and current total sale pool value to enable users of other client devices to access the consolidated sale liquidity pool via a user interface and to submit respective buy orders to buy up to the current total sale pool value. A second data object including data associated with a second sports bet owned by a second sports bettor may be receive from a second client device as made on the sports event. The data may include (i) the first sports event identifier, (ii) the first bet outcome identifier, and (iii) a second hedge bet value less than or equal to a bet value of the second sports bet. The second hedge bet value may be selectably made available for resale by the second sports bettor. In response to determining that the second sports bet includes a second instance of the first bet outcome identifier associated with the first sports event identifier, the processor(s) may second index the second data object with the consolidated sale liquidity pool. In response to the second data object being second indexed with the consolidated sale liquidity pool, an updated current total sale pool value may be calculated by adding the second hedge bet value with the current total sale pool value. The updated current total pool value of the consolidated sale liquidity pool may be communicated to enable the users of the other client devices to access the consolidated sale liquidity pool via the user interface and submit respective buy orders to buy up to the updated current total sale pool value. The buy orders may be at least a fraction of the first and second hedge bet values.

In an embodiment, the processor(s), in dynamically creating the consolidated sale liquidity pool, may be configured to create a first-in, first-out (FIFO) queue in the non-transitory memory, that defines a listing order of the sports bets available to be conditionally purchased from the consolidated sale liquidity pool. The processor(s), in first and second indexing of the respective first and second data objects, may further be configured to first and second index the first and second data objects within the FIFO queue.

The processor(s), in receiving the plurality of respective data objects from client devices, may further be configured to receive the respective data objects that each include a bet sell range specifying a lower range value and an upper range value of an estimated winning bet set by the respective first and second sports bettors. In addition, the processor(s) may further be configured to index the at least one of the first and second data objects of which the current estimated win percentage is between the lower an upper range values on a consolidated sale liquidity ledger to enable at least a fraction of the first and/or second hedge bet values to be sold in response to determining that a received current estimated win percentage associated with the first bet outcome of the first sports event is between the lower and upper range values of at least one of the first and second sports bets.

The processor(s) may further be configured to dynamically create the consolidated sale liquidity ledger associated with the consolidated sale liquidity pool. In dynamically creating the consolidated sale liquidity ledger, the processor(s) may further be configured to dynamically create the consolidated sale liquidity ledger simultaneously with dynamically creating the consolidated sale liquidity pool. In dynamically creating the consolidated sale liquidity ledger, the processor(s) may be configured to dynamically create the consolidated sale liquidity ledger in response to determining that a first instance of the current estimated win percentage associated with the first bet outcome of the existing sports bet is between the lower and upper range values of the at least one of the first and second sports bets.

The processor(s), in dynamically creating the consolidated sale liquidity ledger, may further be configured to dynamically create the consolidated sale liquidity ledger having a FIFO structure such that the hedge bet value of the at least one of the first and second sports bets indexed on the consolidated sale liquidity ledger are available for sale in time-sequential order as ordered on the corresponding consolidated sale liquidity pool.

The processor(s) may further be configured to calculate a total sale ledger value by adding the first and/or second hedge bet value of the at least one of the first and second existing sports bets, where the total sale ledger value may be available for view by the users of the client devices in association with a listing including at least one of the event identifier and bet outcome identifier associated with the existing sports bet.

Still yet, the processor(s), in response to a portion of the total sale ledger value being purchased by a user from the consolidated sale liquidity ledger, may further be configured to (i) determine whether the entirety of the first hedge bet value associated with the first data object is acquired, and if so, de-index the first data object from the consolidated sale liquidity ledger and the consolidated sale liquidity pool. Otherwise, if a determination that the entirety of the at least a portion of the first hedge bet value is not purchased, then the first index of the first data object on the consolidated sale liquidity ledger and the consolidated sale liquidity pool may be maintained. The at least a portion of the first hedge bet value of the first data object may be reduced by the portion of the total sale ledger value purchased by the user. And, (ii) in response to determining that the entirety of the at least a portion of the bet value associated with the first data object is acquired, the processor(s) may further be configured to determine whether the entirety of the second hedge bet value associated with the second data object is acquired, and if so, de-index the second data object from the consolidated sale liquidity ledger and the consolidated sale liquidity pool. Otherwise, if a determination that the entirety of the second hedge bet value of the second data object is not acquired, then the second index of the second data object on the consolidated sale liquidity ledger and the consolidated sale liquidity pool may be maintained. The at least a portion of the first hedge bet value of the second data object may be reduced by the portion of the total sale ledger value purchased by the user greater than the entirety of the first hedge bet value associated with the first data object.

In communicating the at least one of the first sports event identifier, first bet outcome, and current total sale pool value, a listing associated with the sports event may be caused to be accessible via a user interface by the client devices.

The processor(s), in response to receiving a third data object including a first instance of a second bet outcome associated with the first sports event identifier that is different from the first bet outcome associated with the first sports event identifier, may further be configured to dynamically create a second consolidated sale liquidity pool associated with the second bet outcome, and the third data object may be third indexed with the second consolidated sale liquidity pool.

The processor(s) may further be configured to determine whether the sports event associated with the first sports event identifier has completed, and if so, disable the consolidated sale liquidity pool and any consolidated sale liquidity ledger associated therewith. Otherwise, the consolidated sale liquidity pool and any consolidated sale liquidity ledger associated therewith may be maintained. The processor(s) may further be configured to, in response to determining that the sports event has completed, determine whether any of the first hedge bet value and second hedge bet value remains unsold, and if so, the remaining portion of the first and second hedge bet values may be applied back to the sports bets of the respective first and/or second data objects prior to the first and second sports bets being settled.

The processor(s) may further be configured to cause a plurality of consolidated sale liquidity pools to be displayed on the client devices so as to be selectable by a user of a client device to purchase at least a portion of the current total pool value of a selected consolidated sale liquidity pool that includes at least two indexed data objects, thereby enabling the user to simultaneously acquire at least a portion of a plurality of existing hedge bet values from different owners of the sports bets with a single purchase.

The processor(s) may further be configured to, in response to receiving a third data object including (i) a first instance of the first event identifier, (ii) the first bet outcome identifier, and (iii) a first buy value of a first buy order, dynamically create a consolidated buy liquidity pool associated with the first event identifier and the first bet outcome identifier. The consolidated buy liquidity pool may consolidate sports bets to optimize efficiency of energy and communications in transactions of sports bets of sports events with common bet outcomes. The third data object may be first indexed with the consolidated buy liquidity pool. A total buy pool value parameter may be initialized to store a total buy pool value of the consolidated buy liquidity pool with the first buy value. A fourth data object may be received from one of the client devices, where the fourth data object may include (i) the first sports event identifier, (ii) the first bet outcome identifier, and (iii) a second buy value of a second buy order. In response to the processor(s) determining that the second buy order includes a second instance of the first bet outcome identifier associated with the first sports event identifier, the fourth data object may be second indexed with the consolidated buy liquidity pool. In response to the fourth data object being second indexed with the consolidated buy liquidity pool, an updated current total buy pool value may be calculated by adding the second buy value with the current total buy pool value. An automatic determination as to whether any of the total sale pool value is conditionally available to be purchased with any of the current total buy pool value that is conditionally available to be used to purchase the total sale pool value, and if so, the conditionally available total sale pool value may be caused to be purchased by the conditionally available current total buy pool value.

The processor(s), in receiving from the plurality of client devices, the respective third and fourth data objects, may further be configured to receive the third and fourth data objects that each include a buy range specifying a lower range value and an upper range value of an estimated winning bet set by respective third and fourth sports bettors. The processor(s) may further be configured to, in response to determining that a received current estimated win percentage associated with the first bet outcome of the existing sports bet is between the lower and upper range values of at least one of the third and fourth existing sports bets, index the at least one of the third and fourth data objects of which the current estimated win percentage is between the lower an upper range values on a consolidated buy liquidity ledger to enable at least a fraction of the first and/or second hedge bet values to be bought when indexed on the consolidated sell liquidity ledger with (i) the first sports event identifier and (ii) the first bet outcome identifier.

The processor(s) may further be configured to enable an online sports betting platform that sold the first and second sports bets to have priority in purchasing the first and second hedge bet values of the first and second sports bets over sports bettors. The processor(s) may further be configured to, in response to determining a sports bettor seeking who submitted a buy order higher than the at least one of the first and second hedge bet values that is conditionally available for purchase, dynamically enable a new sports bet to be issued to the sports bettor who submitted the buy order higher than the at least one of the first and second hedge bet values that are conditionally available.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

1. A computer-implemented method, comprising:
receiving, by at least one processor from a first client device, a first data object including data associated with a first sports bet owned by a first sports bettor as made on a sports event, the data including (i) a first sports event identifier, (ii) a first bet outcome identifier, and (iii) a first hedge bet value less than or equal to a bet value of the first sports bet, the first hedge bet value selectably made available for resale by the first sports bettor;
in response to the at least one processor determining that the first data object includes a first instance of the first bet outcome identifier associated with the first sports event identifier, dynamically creating, by the at least one processor, a consolidated sale liquidity pool associated with the first sports event identifier and the first bet outcome identifier, the consolidated sale liquidity pool consolidating a plurality of hedge bets to optimize efficiency of energy usage and communications signals in conducting transactions of the hedge bets of the sports event;
first indexing, by the at least one processor, the first data object with the consolidated sale liquidity pool;
initializing, by the at least one processor, a current total sale pool value parameter to store a total sale pool value of the consolidated sale liquidity pool with the first hedge bet value;
communicating, by the at least one processor, at least one of the first event identifier, first bet outcome identifier, and current total sale pool value to enable users of other client devices to access the consolidated sale liquidity pool via a user interface and to submit respective buy orders to buy up to the current total sale pool value;
receiving, by the at least one processor from a second client device, a second data object including data associated with a second sports bet owned by a second sports bettor as made on the sports event, the data including (i) the first sports event identifier, (ii) the first bet outcome identifier, and (iii) a second hedge bet value less than or equal to a bet value of the second sports bet, the second hedge bet value selectably made available for resale by the second sports bettor;
in response to the at least one processor determining that the second sports bet includes a second instance of the first bet outcome identifier associated with the first sports event identifier, second indexing, by the at least one processor, the second data object with the consolidated sale liquidity pool;
in response to the second data object being second indexed with the consolidated sale liquidity pool, calculating an updated current total sale pool value by adding the second hedge bet value with the current total sale pool value; and
communicating, by the at least one processor, the updated current total pool value of the consolidated sale liquidity pool to enable the users of the other client devices to access the consolidated sale liquidity pool via the user interface and submit respective buy orders to buy up to the updated current total sale pool value, the buy orders being at least a fraction of the first and second hedge bet values.

2. The method according to claim 1, wherein dynamically creating, by the at least one processor, the consolidated sale liquidity pool includes creating a first-in, first-out (FIFO) queue that defines a listing order of the sports bets available to be conditionally purchased from the consolidated sale liquidity pool, and wherein the first and second indexing of the respective first and second data objects includes first and second indexing the first and second data objects within the FIFO queue.

3. The method according to claim 2,
wherein receiving, by the at least one processor, from the plurality of client devices, the plurality of respective data objects further includes receiving the plurality of respective data objects that each include a bet sell range specifying a lower range value and an upper range value of an estimated winning bet set by the respective first and second sports bettors, and further comprising:
in response to determining that a received current estimated win percentage associated with the first bet outcome of the first sports event is between the lower and upper range values of at least one of the first and second sports bets, indexing the at least one of the first and second data objects of which the current estimated win percentage is between the lower an upper range values on a consolidated sale liquidity ledger to enable at least a fraction of the first and/or second hedge bet values to be sold.

4. The method according to claim 3, further comprising dynamically creating, by the at least one processor, the consolidated sale liquidity ledger associated with the consolidated sale liquidity pool.

5. The method according to claim 4, wherein dynamically creating, by the at least one processor, the consolidated sale liquidity ledger includes dynamically creating the consolidated sale liquidity ledger simultaneously with dynamically creating the consolidated sale liquidity pool.

6. The method according to claim 4, wherein dynamically creating, by the at least one processor, the consolidated sale liquidity ledger includes dynamically creating the consolidated sale liquidity ledger in response to determining that a first instance of the current estimated win percentage associated with the first bet outcome of the existing sports bet is between the lower and upper range values of the at least one of the first and second sports bets.

7. The method according to claim 4, wherein dynamically creating the consolidated sale liquidity ledger includes dynamically creating, by the at least one processor, the consolidated sale liquidity ledger having a FIFO structure such that the hedge bet value of the at least one of the first and second sports bets indexed on the consolidated sale liquidity ledger are available for sale in time-sequential order as ordered on the corresponding consolidated sale liquidity pool.

8. The method according to claim 4, further comprising calculating, by the at least one processor, a total sale ledger value by adding the first and/or second hedge bet value of the at least one of the first and second existing sports bets, the total sale ledger value being available for view by the users of the client devices in association with a listing including at least one of the event identifier and bet outcome identifier associated with the existing sports bet.

9. The method according to claim 8, wherein in response to a portion of the total sale ledger value being purchased by a user from the consolidated sale liquidity ledger,
(i) determining whether the entirety of the first hedge bet value associated with the first data object is acquired, and if so, de-indexing the first data object from the consolidated sale liquidity ledger and the consolidated sale liquidity pool, otherwise, if a determination that the entirety of the at least a portion of the first hedge bet value is not purchased, then:
maintaining the first index of the first data object on the consolidated sale liquidity ledger and the consolidated sale liquidity pool; and
reducing the at least a portion of the first hedge bet value of the first data object by the portion of the total sale ledger value purchased by the user; and
(ii) in response to determining that the entirety of the at least a portion of the bet value associated with the first data object is acquired, further comprising determining whether the entirety of the second hedge bet value associated with the second data object is acquired, and if so, de-indexing the second data object from the consolidated sale liquidity ledger and the consolidated sale liquidity pool, otherwise, if a determination that the entirety of the second hedge bet value of the second data object is not acquired, then:
maintaining the second index of the second data object on the consolidated sale liquidity ledger and the consolidated sale liquidity pool; and
reducing the at least a portion of the first hedge bet value of the second data object by the portion of the total sale ledger value purchased by the user greater than the entirety of the first hedge bet value associated with the first data object.

10. The method according to claim 1, wherein communicating, by the at least one processor, the at least one of the first sports event identifier, first bet outcome, and current total sale pool value causes a listing associated with the sports event to be accessible via a user interface by the client devices.

11. The method according to claim 10, wherein in response to receiving a third data object including a first instance of a second bet outcome associated with the first sports event identifier that is different from the first bet outcome associated with the first sports event identifier:
dynamically creating, by the at least one processor, a second consolidated sale liquidity pool associated with the second bet outcome; and
third indexing the third data object with the second consolidated sale liquidity pool.

12. The method according to claim 1, further comprising determining whether the sports event associated with the first sports event identifier has completed, and if so, disabling the consolidated sale liquidity pool and any consolidated sale liquidity ledger associated therewith, otherwise, maintaining the consolidated sale liquidity pool and any consolidated sale liquidity ledger associated therewith.

13. The method according to claim 12, further comprising, in response to determining that the sports event has completed, determining whether any of the first hedge bet value and second hedge bet value remains unsold, and if so, applying the remaining portion of the first and second hedge bet values back to the sports bets of the respective first and/or second data objects prior to the first and second sports bets being settled.

14. The method according to claim 1, further comprising causing, by the at least one processor, a plurality of consolidated sale liquidity pools to be displayed on the client devices so as to be selectable by a user of a client device to purchase at least a portion of the current total pool value of a selected consolidated sale liquidity pool that includes at least two indexed data objects, thereby enabling the user to simultaneously acquire at least a portion of a plurality of existing hedge bet values from different owners of the sports bets with a single purchase.

15. The method according to claim 1, further comprising:
in response to receiving, by the at least one processor from one of the client devices, a third data object including (i) a first instance of the first event identifier, (ii) the first bet outcome identifier, and (iii) a first buy value of a first buy order, dynamically creating, by the at least one processor, a consolidated buy liquidity pool associated with the first event identifier and the first bet outcome identifier, the consolidated buy liquidity pool consolidating sports bets to optimize efficiency of energy and communications in transactions of sports bets of sports events with common bet outcomes;
first indexing the third data object with the consolidated buy liquidity pool;
initializing, by the at least one processor, a total buy pool value parameter to store a total buy pool value of the consolidated buy liquidity pool with the first buy value;
receive, by the at least one processor from one of the client devices, a fourth data object including (i) the first sports event identifier, (ii) the first bet outcome identifier, and (iii) a second buy value of a second buy order;
in response to the at least one processor determining that the second buy order includes a second instance of the first bet outcome identifier associated with the first sports event identifier, second indexing the fourth data object with the consolidated buy liquidity pool;
in response to the fourth data object being second indexed with the consolidated buy liquidity pool, calculating an updated current total buy pool value by adding the second buy value with the current total buy pool value; and
automatically determining, by the at least one processor, whether any of the total sale pool value is conditionally available to be purchased with any of the current total buy pool value that is conditionally available to be used to purchase the total sale pool value, and if so, causing the conditionally available total sale pool value to be purchased by the conditionally available current total buy pool value.

16. The method according to claim 15,
wherein receiving, by the at least one processor, from the plurality of client devices, the respective third and fourth data objects further includes receiving the third and fourth data objects that each include a buy range specifying a lower range value and an upper range value of an estimated winning bet set by respective third and fourth sports bettors, and further comprising:
in response to determining that a received current estimated win percentage associated with the first bet outcome of the existing sports bet is between the lower and upper range values of at least one of the third and fourth existing sports bets, indexing the at least one of the third and fourth data objects of which the current estimated win percentage is between the lower an upper range values on a consolidated buy liquidity ledger to enable at least a fraction of the first and/or second hedge bet values to be bought when indexed on the consolidated sell liquidity ledger with (i) the first sports event identifier and (ii) the first bet outcome identifier.

17. The method according to claim 1, further comprising enabling, by the at least one processor, an online sports betting platform that sold the first and second sports bets to have priority in purchasing the first and second hedge bet values of the first and second sports bets over sports bettors.

18. The method according to claim 17, further comprising, in response to the at least one processor determining a sports bettor seeking who submitted a buy order higher than the at least one of the first and second hedge bet values that is conditionally available for purchase, dynamically enabling, by the at least one processor to issue a new sports bet to the sports bettor who submitted the buy order higher than the at least one of the first and second hedge bet values that are conditionally available.

19-36. (canceled)
